(19) United States
(12) Patent Application Publication
(10) Pub. No.: US 2026/0353125 A1
(43) Pub. Date: Nov. 5, 2026

(54) INFORMATION PROCESSING METHOD AND APPARATUS, COMMUNICATION DEVICE, COMMUNICATION SYSTEM, AND STORAGE MEDIUM

(71) Applicant: BEIJING XIAOMI MOBILE SOFTWARE CO., LTD., Beijing (CN)

(72) Inventors: Jinhua WU, Beijing (CN); Yang SHEN, Beijing (CN)

(73) Assignee: BEIJING XIAOMI MOBILE SOFTWARE CO., LTD., Beijing (CN)

(21) Appl. No.: 19/486,220

(22) PCT Filed: May 22, 2023
(86) PCT No.: PCT/CN2023/095613

§ 371 Date: Nov. 20, 2025

(51) Int. Cl. H04W 24/08

(52) U.S. Cl. CPC H04W 24/08

(57) ABSTRACT

An information processing method is executed by a first network element, and comprises: sending a first request message, wherein the first request message is configured to first information of QoS monitoring and the first information indicates one of the following: a TTNB; and the TTNB and a time interval between starts of two bursts.

### CROSS-REFERENCE TO RELATED APPLICATION

This application is the US national phase application of International Application No. PCT/CN2023/095613, filed on May 22, 2023, the entire contents of which are incorporated herein by reference for all purposes.

### TECHNICAL FIELD

The present disclosure relates to a field of communication technology, and specifically to an information processing method and apparatus, a communication device, a communication system, and a storage medium.

### BACKGROUND

With the continuous development of wireless communication technology, many services, such as a multimedia virtual reality (XRM) service, have also developed rapidly. Due to characteristics such as high bandwidth, low latency, and/or reliability requirements of the service, new challenges are posed to data scheduling and/or transmission.

### SUMMARY

Embodiments of the present disclosure provide an information processing method and apparatus, a communication device, a communication system, and a storage medium.

According to a first aspect of the embodiments of the present disclosure, an information processing method is provided, performed by a first network element, including: sending a first request message, in which the first request message is configured to request first information of quality of service (QoS) monitoring; and the first information indicates one of: a time to next burst (TTNB); or a TTNB and a time interval between starts of two bursts.

According to a second aspect of the embodiments of the present disclosure, an information processing method is provided, performed by a second network element, including: receiving a first request message, in which the first request message is configured to request first information of QoS monitoring; and the first information indicates at least one of: a TTNB; or a TTNB and a time interval between starts of two bursts.

According to a third aspect of the embodiments of the present disclosure, an information processing method is provided, performed by a fourth network element, including: sending a second request message to a fifth network element, in which the second request message indicates QoS monitoring, and the second request message is configured to request first information of the QoS monitoring; and the first information indicates one of: a TTNB; or a TTNB and a time interval between starts of two bursts.

According to a fourth aspect of the embodiments of the present disclosure, an information processing method is provided, performed by a fifth network element, including: receiving a second request message sent by a fourth network element, in which the second request message indicates QoS monitoring, and the second request is configured to request first information of the QoS monitoring; and the first information indicates one of: a TTNB; or a TTNB and a time interval between starts of two bursts.

According to a fifth aspect of the embodiments of the present disclosure, an information processing method is provided, performed by a communication system, in which the communication system includes a core network device and a first network element; and the method includes: sending, by the first network element, a first request message to the core network device, in which the first request message is configured to request first information of QoS monitoring, and the first information indicates at least one of: a TTNB, or a TTNB and a time interval between starts of two bursts; performing, by the core network device, the QoS monitoring to obtain a monitoring report of the first information; and sending, by the core network device, the monitoring report to the first network element.

According to a sixth aspect of the embodiments of the present disclosure, an information processing method is provided, performed by a core network device, in which the core network device includes a fourth network element and a fifth network element; and the method includes: sending, by the fourth network element, a second request message to the fifth network element, in which the second request message indicates QoS monitoring, and the second request message is configured to request first information of the QoS monitoring, and the first information indicates one of: a TTNB, or a TTNB and a time interval between starts of two bursts; performing, by the fifth network element, the QoS monitoring to obtain a monitoring report of the first information; and sending, by the fifth network element, the monitoring report to the fourth network element.

According to a seventh aspect of the embodiments of the present disclosure, a first information processing apparatus is provided, including: a first sending module, configured to send a first request message, in which the first request message is configured to request first information of QoS monitoring; and the first information indicates one of: a TTNB; or a TTNB and a time interval between starts of two bursts.

According to an eighth aspect of the embodiments of the present disclosure, a second information processing apparatus is provided, including: a second receiving module, configured to receive a first request message, in which the first request message is configured to request first information of QoS monitoring; and the first information indicates at least one of: a TTNB; or a TTNB and a time interval between starts of two bursts.

According to a ninth aspect of the embodiments of the present disclosure, a third information processing apparatus is provided, including: a third sending module, configured to send a second request message to a fifth network element, in which the second request message indicates QoS monitoring, and the second request message is configured to request first information of the QoS monitoring; and the first information indicates one of: a TTNB; or a TTNB and a time interval between starts of two bursts.

According to a tenth aspect of the embodiments of the present disclosure, a fourth information processing apparatus is provided, including: a fourth receiving module, configured to receive a second request message sent by a fourth network element, in which the second request message indicates QoS monitoring, and the second request is configured to request first information of the QoS monitoring; and the first information indicates one of: a TTNB; or a TTNB and a time interval between starts of two bursts.

According to an eleventh aspect of the embodiments of the present disclosure, a communication device is provided, including: one or more processors, in which the processor is configured to invoke instructions to cause the communication device to implement the information processing method described in the first aspect, the second aspect, the third aspect, the fourth aspect, the fifth aspect, the sixth aspect, or to implement the information processing method described in optional implementations of the first aspect, the second aspect, the third aspect, the fourth aspect, the fifth aspect, and the sixth aspect.

According to a twelfth aspect of the embodiments of the present disclosure, an information processing system is provided, including: a first network element, a second network element, a third network element, and a fourth network element, in which the first network element is configured to implement the information processing method described in optional implementations of the first aspect, the second network element is configured to implement the information processing method described in optional implementations of the second aspect, the third network element is configured to implement the information processing method described in optional implementations of the third aspect, the fourth network element is configured to implement the information processing method described in optional implementations of the fourth aspect.

According to a thirteenth aspect of the embodiments of the present disclosure, a storage medium for storing instructions is provided, when running on a communication device, the communication device is caused to implement the information processing method described in the first aspect, the second aspect, the third aspect, the fourth aspect, the fifth aspect, the sixth aspect, or the information processing method described in optional implementations of the first aspect, the second aspect, the third aspect, the fourth aspect, the fifth aspect, and the sixth aspect.

### BRIEF DESCRIPTION OF THE DRAWINGS

In order to more clearly illustrate the technical solution in the embodiments of the disclosure, the accompanying drawings to be used in the embodiments of the disclosure will be described below. The following drawings are only part embodiments of the present disclosure, and do not constitute a limitation on the protection scope of the present disclosure.

FIG. 1 is a schematic diagram of a structure of an information processing system according to an embodiment of the present disclosure.

FIG. 2 is a schematic diagram of an interaction of an information processing method according to an embodiment of the present disclosure.

FIG. 3A is a flowchart of an information processing method according to an embodiment of the present disclosure.

FIG. 3B is a flowchart of an information processing method according to an embodiment of the present disclosure.

FIG. 4A is a flowchart of an information processing method according to an embodiment of the present disclosure.

FIG. 4B is a flowchart of an information processing method according to an embodiment of the present disclosure.

FIG. 5A is a flowchart of an information processing method according to an embodiment of the present disclosure.

FIG. 5B is a flowchart of an information processing method according to an embodiment of the present disclosure.

FIG. 5C is a flowchart of an information processing method according to an embodiment of the present disclosure.

FIG. 6A is a flowchart of an information processing method according to an embodiment of the present disclosure.

FIG. 6B is a flowchart of an information processing method according to an embodiment of the present disclosure.

FIG. 7A is a flowchart of an information processing method according to an embodiment of the present disclosure.

FIG. 7B is a flowchart of an information processing method according to an embodiment of the present disclosure.

FIG. 8A is a flowchart of an information processing method according to an embodiment of the present disclosure.

FIG. 8B is a flowchart of an information processing method according to an embodiment of the present disclosure.

FIG. 9A is a block diagram of an information processing apparatus according to an embodiment of the present disclosure.

FIG. 9B is a block diagram of an information processing apparatus according to an embodiment of the present disclosure.

FIG. 9C is a block diagram of an information processing apparatus according to an embodiment of the present disclosure.

FIG. 9D is a block diagram of an information processing apparatus according to an embodiment of the present disclosure.

FIG. 10A is a block diagram of a structure of a communication device according to an embodiment of the present disclosure.

FIG. 10B is a block diagram of a structure of a chip according to an embodiment of the present disclosure.

### DETAILED DESCRIPTION

The embodiments of the present disclosure need to solve problems of balancing energy saving and user experience.

The embodiments of the present disclosure provide an information processing method and apparatus, a communication device, a communication system, and a storage medium.

According to a first aspect, the embodiments of the present disclosure provide an information processing method, performed by a first network element, including: sending a first request message, in which the first request message is configured to request first information of quality of service (QOS) monitoring; and the first information indicates one of: a time to next burst (TTNB); or a TTNB and a time interval between starts of two bursts.

In the above embodiment, the first network element may request the first information of the QoS monitoring, that is, may at least request a monitoring report of the TTNB, thus enabling more accurate prediction of a time interval between an end time of a previous burst and a start time of a next burst among the two bursts, enabling more accurate prediction and/or adjustment of a discontinuous reception (DRX) cycle of the terminal, and further facilitating balancing energy consumption of the terminal and a quality of experience (QoE) of the user.

In combination with some embodiments of the first aspect, in some embodiments, sending the first request information includes one of: sending the first request message in an application function (AF) session establishment procedure; or sending the first request message in an AF session modification procedure.

In the above embodiment, the first network element may send the first request message in the AF session establishment procedure or in the AF session modification procedure. On one hand, the first network element may adapt to more application scenarios for sending the first request message; on the other hand, the first network element may send the first request message using an existing message or signaling in the AF session establishment procedure or the AF session modification procedure, thus reusing messages or signalings and further saving signaling overhead, etc.

In combination with some embodiments of the first aspect, in some embodiments, sending the first request message includes one of: sending the first request message to a second network element; or sending the first request message to a second network element via a third network element.

In the above embodiment, the first network element may send the first request message to the second network element directly or indirectly, thus adapting to more application scenarios. Furthermore, if the first network element sends the first request message to the second network element via the third network element, whether the first network element is a trusted first network element may also be verified, thus improving network security.

In combination with some embodiments of the first aspect, in some embodiments, the method further includes one of: receiving a monitoring report of the first information sent by the second network element; or receiving a monitoring report of the first information sent by the second network element via the third network element.

In the above embodiment, the first network element may receive the monitoring report of the first information in various ways, thus adapting to more application scenarios. Moreover, the monitoring report may enable the AF to more accurately predict a DRX cycle of the terminal, etc., thus enabling better communication between the first network element and the core network device.

In combination with some embodiments of the first aspect, in some embodiments, the first network element is an AF; and/or the second network element is a policy control function (PCF); and/or the third network element is a network exposure function (NEF).

In the above embodiment, the first network element being the AF and the second network element being the PCF may enable an AF outside the core network to also subscribe to the TTNB (for example, by receiving the monitoring report of the first information via the PCF), etc., thus facilitating communication between the AF and the core network device. And/or, if the third network element is the NEF, authentication of whether the AF is a trusted AF may be achieved.

According to a second aspect, the embodiments of the present disclosure provide an information processing method, performed by a second network element, including: receiving a first request message, in which the first request message is configured to request first information of QoS monitoring; and the first information indicates at least one of: a TTNB; or a TTNB and a time interval between starts of two bursts.

In combination with some embodiments of the second aspect, in some embodiments, receiving the first request message includes one of: receiving the first request message sent by a first network element; or receiving the first request message sent by a first network element via a third network element.

In combination with some embodiments of the second aspect, in some embodiments, the method includes: determining first policy information based on the first request message, in which the first policy information indicates a policy of the QoS monitoring; and sending the first policy information to a fourth network element.

In the above embodiment, the second network element may determine the first policy information and send the first policy information to the fourth network element, which is beneficial for the fourth network element to configure the policy of the QoS monitoring to a fifth network element, i.e., beneficial for realizing configuration of the policy of the QoS monitoring. Moreover, since the policy of the QoS monitoring is configured by the second network element, the policy may be used in a plurality of access networks, thus enabling unified configuration, etc.

In combination with some embodiments of the second aspect, in some embodiments, sending the first policy information to the fourth network element includes: sending policy and charging control (PCC) rule information to the fourth network element, in which the PCC rule information includes the first policy information.

In the above embodiment, the first policy information may be sent via the PCC rule information without a need for an extra signaling to send the first policy information, which may save signaling overhead.

In combination with some embodiments of the second aspect, in some embodiments, the method further includes: receiving a monitoring report of the first information sent by a fourth network element; and sending the monitoring report to the first network element.

In the above embodiment, the second network element may be aware of the monitoring report, which is beneficial for the second network element to predict a DRX cycle of the terminal and to update the PCC rule, etc., thus enabling an updated PCC rule to adapt to characteristics of multimodal data flows, etc., and improving transmission measurement and optimizing traffic charging, etc.

Furthermore, the monitoring report may also be sent to the first network element, so that the first network element is aware of the monitoring report, and determines the DRX cycle of the terminal more accurately, etc.

In combination with some embodiments of the second aspect, in some embodiments, the first network element is an AF; and/or the second network element is a PCF; and/or the third network element is an NEF; and/or the fourth network element is a session management function (SMF).

According to a third aspect, the embodiments of the present disclosure provide an information processing method, performed by a fourth network element, including: sending a second request message to a fifth network element, in which the second request message indicates QoS monitoring, and the second request message is configured to request first information of the QoS monitoring; and the first information indicates one of: a TTNB; or a TTNB and a time interval between starts of two bursts.

In the above embodiment, the fourth network element may indicate the fifth network element to perform the QoS monitoring, which is beneficial to obtain a monitoring report corresponding to the first information of the QoS monitoring, thus enabling more accurate prediction and/or adjustment of the DRX of the terminal, etc., which is beneficial for balancing energy consumption of the terminal and a QoE of the user.

In combination with some embodiments of the third aspect, in some embodiments, the second request message includes policy information, and the policy information indicates a policy of the QoS monitoring.

In the above embodiment, by delivering the policy information, it is beneficial for the fifth network element to perform the QoS monitoring according to a policy indicated by the policy information.

In combination with some embodiments of the third aspect, in some embodiments, the policy information includes first policy information; and the method further includes: receiving the first policy information sent by a second network element.

In the above embodiment, the fourth network element may obtain the first policy information indicating the policy of the QoS monitoring from the second network element.

In combination with some embodiments of the third aspect, in some embodiments, the policy information includes second policy information; and the method further includes: determining the second policy information based on at least one of the first policy information or local configuration information.

In the above embodiment, the fourth network element may also determine the second policy information indicating the policy of the QoS monitoring by itself, thus making it more suitable for QoS monitoring of a current access network device.

In combination with some embodiments of the third aspect, in some embodiments, the policy information includes at least one of: first indication information, indicating a monitoring object of the QoS monitoring; second indication information, indicating a period for reporting a monitoring report of the first information; third indication information, indicating a reporting type for reporting a monitoring report of the first information, in which the reporting type includes: a periodic reporting type or an event triggered reporting type; or fourth indication information, indicating a target object to which a monitoring report of the first information is reported, in which the target object includes at least one of: an access network device, a first network element, a second network element, a third network element, or the fourth network element.

In the above embodiment, by configuring at least one of the monitoring object of the QoS monitoring, the period for reporting the monitoring report, the reporting mode of the monitoring report, and the target object, it is beneficial for the fifth network element to implement more accurate execution of the QoS monitoring and to report the monitoring report.

In combination with some embodiments of the third aspect, in some embodiments, the method includes: receiving a monitoring report of the first information sent by the fifth network element.

In combination with some embodiments of the third aspect, in some embodiments, the method includes at least one of: sending the monitoring report to a second network element; sending the monitoring report to an access network device via a sixth network element; sending the monitoring report to an access network device via a next generation application protocol (NGAP) message; sending the monitoring report to a first network element; or sending the monitoring report to a third network element via a second network element.

In the above embodiment, the monitoring report sent by the fifth network element may be transmitted to different network elements via different transmission methods or paths, which is beneficial for these network elements to perform corresponding operations based on the monitoring report and to adapt to more wireless communication functions, etc., and can achieve flexible forwarding.

In combination with some embodiments of the third aspect, in some embodiments, the first network element is an AF; and/or the second network element is a PCF; and/or the third network element is an NEF; and/or the fourth network element is an SMF; and/or the fifth network element is a user plane function (UPF); and/or the sixth network element is an access and mobility management function (AMF).

According to a fourth aspect, the embodiments of the present disclosure provide an information processing method, performed by a fifth network element, including: receiving a second request message sent by a fourth network element, in which the second request message indicates QoS monitoring, and the second request is configured to request first information of the QoS monitoring; and the first information indicates one of: a TTNB; or a TTNB and a time interval between starts of two bursts.

In combination with some embodiments of the fourth aspect, in some embodiments, the second request message includes policy information, and the policy information indicates a policy of the QoS monitoring.

In combination with some embodiments of the fourth aspect, in some embodiments, the policy information includes at least one of: first indication information, indicating a monitoring object of the QoS monitoring; second indication information, indicating a period for reporting a monitoring report of the first information; third indication information, indicating a reporting type for reporting a monitoring report of the first information, in which the reporting type includes a periodic reporting type or an event triggered reporting type; or fourth indication information, indicating a target object to which a monitoring report of the first information is reported, in which the target object includes at least one of: an access network device, a first network element, a second network element, a third network element, or the fourth network element.

In combination with some embodiments of the fourth aspect, in some embodiments, the method includes: obtaining a monitoring report of the first information by performing the QoS monitoring based on the second request message.

In combination with some embodiments of the fourth aspect, in some embodiments, the method includes at least one of: sending the monitoring report to the fourth network element; sending the monitoring report to a first network element; sending the monitoring report to a third network element; or sending the monitoring report to an access network device via a data packet of a General Packet Radio Service Tunneling Protocol-User Plane (GTP-U).

In the above embodiment, the fifth network element may directly send the monitoring report to the target object, or may forward the monitoring report to the target object via other network elements, which may meet needs of various network elements, etc.

In combination with some embodiments of the fourth aspect, in some embodiments, the first network element is an AF; and/or the third network element is an NEF; and/or the fourth network element is an SMF; and/or the fifth network element is a UPF.

According to a fifth aspect, the embodiments of the present disclosure provide an information processing method, performed by a communication system, in which the communication system includes a core network device and a first network element; and the method includes: sending, by the first network element, a first request message to the core network device, in which the first request message is configured to request first information of QoS monitoring, and the first information indicates at least one of: a TTNB, or a TTNB and a time interval between starts of two bursts; performing, by the core network device, the QoS monitoring to obtain a monitoring report of the first information; and sending, by the core network device, the monitoring report to the first network element.

According to a sixth aspect, the embodiments of the present disclosure provide an information processing method, performed by a core network device, in which the core network device includes a fourth network element and a fifth network element; and the method includes: sending, by the fourth network element, a second request message to the fifth network element, in which the second request message indicates QoS monitoring, and the second request message is configured to request first information of the QoS monitoring, and the first information indicates one of: a TTNB, or a TTNB and a time interval between starts of two bursts; performing, by the fifth network element, the QoS monitoring to obtain a monitoring report of the first information; and sending, by the fifth network element, the monitoring report to the fourth network element.

In combination with some embodiments of the sixth aspect, in some embodiments, the core network device further includes a second network element; and the method further includes: sending, by the second network element, first policy information to the fourth network element, in which the first policy information indicates a policy of the QoS monitoring.

In combination with some embodiments of the sixth aspect, in some embodiments, the method further includes: determining second policy information based on at least one of the first policy information or local configuration information, in which the second policy information indicates the policy of the QoS monitoring.

According to a seventh aspect, the embodiments of the present disclosure provide a first information processing apparatus, including: a first sending module, configured to send a first request message, in which the first request message is configured to request first information of QoS monitoring; and the first information indicates one of: a TTNB; or a TTNB and a time interval between starts of two bursts.

According to an eighth aspect, the embodiments of the present disclosure provide a second information processing apparatus, including: a second receiving module, configured to receive a first request message, in which the first request message is configured to request first information of QoS monitoring; and the first information indicates at least one of: a TTNB; or a TTNB and a time interval between starts of two bursts.

According to a ninth aspect, the embodiments of the present disclosure provide a third information processing apparatus, including: a third sending module, configured to send a second request message to a fifth network element, in which the second request message indicates QoS monitoring, and the second request message is configured to request first information of the QoS monitoring; and the first information indicates one of: a TTNB; or a TTNB and a time interval between starts of two bursts.

According to a tenth aspect, the embodiments of the present disclosure provide a fourth information processing apparatus, including: a fourth receiving module, configured to receive a second request message sent by a fourth network element, in which the second request message indicates QoS monitoring, and the second request is configured to request first information of the QoS monitoring; and the first information indicates one of: a TTNB; or a TTNB and a time interval between starts of two bursts.

According to an eleventh aspect, the embodiments of the present disclosure provide a communication device, including: one or more processors, in which the processor is configured to invoke instructions to cause the communication device to implement the information processing method described in the first aspect, the second aspect, the third aspect, the fourth aspect, the fifth aspect, the sixth aspect, or the information processing method described in optional implementations of the first aspect, the second aspect, the third aspect, the fourth aspect, the fifth aspect, and the sixth aspect.

According to a twelfth aspect, the embodiments of the present disclosure provide an information processing system, including: a first network element, a second network element, a third network element, and a fourth network element, in which the first network element is configured to implement the information processing method described in optional implementations of the first aspect, the second network element is configured to implement the information processing method described in optional implementations of the second aspect, the third network element is configured to implement the information processing method described in optional implementations of the third aspect, the fourth network element is configured to implement the information processing method described in optional implementations of the fourth aspect.

According to a thirteenth aspect, the embodiments of the present disclosure provide a storage medium for storing instructions that, when running on a communication device, the communication device is caused to implement the information processing method described in the first aspect, the second aspect, the third aspect, the fourth aspect, the fifth aspect, the sixth aspect, or the information processing method described in optional implementations of the first aspect, the second aspect, the third aspect, the fourth aspect, the fifth aspect, and the sixth aspect.

According to a fourteenth aspect, the embodiments of the present disclosure provide a program product. When the program product is executed by a communication device, the communication device is caused to implement the information processing method described in the first aspect, the second aspect, the third aspect, the fourth aspect, the fifth aspect, the sixth aspect, or the information processing method described in optional implementations of the first aspect, the second aspect, the third aspect, the fourth aspect, the fifth aspect, and the sixth aspect.

According to a fifteenth aspect, the embodiments of the present disclosure provide a computer program. When the computer program is running on a computer, the computer is caused to implement the information processing method described in the first aspect, the second aspect, the third aspect, the fourth aspect, the fifth aspect, the sixth aspect, or the information processing method described in optional implementations of the first aspect, the second aspect, the third aspect, the fourth aspect, the fifth aspect, and the sixth aspect.

It may be understood that the first information processing apparatus, the second information processing apparatus, the third information processing apparatus, the fourth information processing apparatus, the communication device, the communication system, the storage medium, the program product, and the computer program are all configured to implement the method provided by the embodiments of the present disclosure. Therefore, for beneficial effects they may achieve, reference may be made to beneficial effects in the corresponding method, which will not be repeated here.

The embodiments of the present disclosure provide an information processing method and apparatus, a communication device, a communication system, and a storage medium. In some embodiments, the term “information processing method” may be interchangeable with the term such as “communication method”, the term “information processing apparatus” may be interchangeable with the term such as “communication apparatus”, and the term “information processing system” may be interchangeable with the term such as “communication system”.

The embodiments of the present disclosure are not exhaustive and only serve as illustrations of some embodiments, but not as specific limitations to the protection scope of the present disclosure. Without conflict, each step in an embodiment may be implemented as an independent embodiment, and steps may be arbitrarily combined. For example, a solution obtained by removing some steps from an embodiment may also be implemented as an independent embodiment. A sequence of steps in an embodiment may be arbitrarily exchanged. In addition, optional implementations in an embodiment may be arbitrarily combined. Furthermore, different embodiments may be arbitrarily combined. For example, some or all steps of different embodiments may be arbitrarily combined, and an embodiment may be arbitrarily combined with optional implementations of other embodiments.

In various embodiments of the present disclosure, unless otherwise specified and having logical conflicts, terms and/or descriptions are consistent in all embodiments and reference may be made to each other. Technical features from different embodiments may be combined to form a new embodiment based on their inherent logical relationships.

The terms used in the embodiments of the present disclosure are for a purpose of describing specific embodiments only and are not intended to limit the present disclosure.

In the embodiments of the present disclosure, unless otherwise specified, elements expressed in a singular form, such as “a”, “an”, “the”, “said”, “above”, “aforementioned”, “this” etc. may mean “one and only one” or may mean “one or more”, “at least one”, etc. For example, when articles such as “a”, “an”, or “the” are used, the noun following the article may be understood in the singular form or in the plural form.

In the embodiments of the present disclosure, “a plurality of” means two or more than two.

In some embodiments, terms such as “at least one of”, “one or more”, “a plurality of”, “multiple”, etc. may be used interchangeably.

In some embodiments, descriptions such as “at least one of A or B”, “A and/or B”, “in a case A, in another case B” and “in response to a case A, in response to another case B” may include following technical solutions depending on different conditions: performing A regardless of B, i.e., performing A in some embodiments; performing B regardless of A, i.e., performing B in some embodiments; selectively performing A or B, i.e., selectively performing A or B in some embodiments; and performing both A and B, i.e., performing both A and B in some embodiments. The similar principle applies when there are more branches such as A, B, C, etc.

In some embodiments, expressions such as “A or B” may include following technical solutions depending on different conditions: performing A regardless of B, i.e., performing A in some embodiments; performing B regardless of A, i.e., performing B in some embodiments; selectively performing A or B, i.e., selectively performing A or B in some embodiments; and performing both A and B, i.e., performing both A and B in some embodiments. The similar principle applies when there are more branches such as A, B, C, etc.

The terms such as “first” and “second” added in front of other words in the embodiments of the present disclosure are used solely to distinguish different described objects and do not limit a position, a sequence, a priority, a quantity, or content of the described objects. For a statement regarding the described object, reference may be made to claims or descriptions in the context of the embodiments and should not constitute other restrictions due to the use of the above terms in front of other words. For example, if the described object is “field”, ordinal numbers before the “field” in “first field” and “second field” do not limit a position or a sequence between fields. “First” and “second” do not limit whether described “fields” are in a same message, nor do an order of the “first field” and the “second field.” For another example, if the described object is “level”, ordinal numbers before the “level” in “first level” and “second level” do not limit a priority between levels. Furthermore, a quantity of described objects is not limited by the ordinal numbers, which may be one or more. Taking “first apparatus” as an example, there may be one or more “apparatus”. In addition, objects modified by different prefix words may be the same or different. For example, if the described object is an “apparatus”, “first apparatus” and “second apparatus” may be a same apparatus or different apparatuses, and their types may be the same or different. Similarly, if the described object is “information”, “first information” and “second information” may be same information or different information, and their content may be the same or different.

In some embodiments, “including A”, “comprising A” “configured to indicate A”, or “carrying A” may be interpreted as directly carrying A or indirectly indicating A.

In some embodiments, terms such as “in response to . . . ” , “in response to determining . . . ” , “in a case that . . . ”, “when . . . ” , “if . . . ” etc. may be used interchangeably.

In some embodiments, the terms such as “greater than”, “greater than or equal to”, “not less than”, “more than”, “more than or equal to”, “no less than”, “higher than”, “higher than or equal to”, “not lower than”, “above”, etc. may be used interchangeably. The terms such as “less than”, “less than or equal to”, “not greater than”, “fewer than”, “fewer than or equal to”, “no more than”, “lower than”, “lower than or equal to”, “not higher than”, “below” etc. may also be used interchangeably.

In some embodiments, “apparatus” may be interpreted as either a physical apparatus or a virtual apparatus. Names are not limited to those recorded in embodiments. The terms such as “apparatus”, “equipment”, “device”, “circuit”, “network element”, “node”, “function”, “unit”, “section”, “system”, “network”, “chip”, “chip system”, “entity”, “subject”, etc. may be used interchangeably.

In some embodiments, “network” may be interpreted as a device included within the network (such as an access network device, a core network device, etc.).

In some embodiments, terms such as “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier”, “bandwidth part (BWP)”, etc. may be used interchangeably.

In some embodiments, terms such as “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, etc. may be used interchangeably.

In some embodiments, an access network device, a core network device, or a network device may be replaced by a terminal. For example, the embodiments of the present disclosure may also be applied to a structure where communication between the access network device, the core network device, or the network device and the terminal is replaced by communication among a plurality of terminals (e.g., device-to-device (D2D), or vehicle-to-everything (V2X), etc.). In this case, the terminal may be set to have all or part of functions of the access network device. In addition, terms such as “uplink” and “downlink” may be replaced with terms corresponding to terminal-to-terminal communication (e.g., “sidelink”). For example, an uplink channel or a downlink channel may be replaced with a sidelink channel; and an uplink or a downlink may be replaced with a sidelink.

In some embodiments, the terminal may be replaced with the access network device, the core network device, or the network device. In this case, the access network device, the core network device, or the network device may be set to have all or part of functions of the terminal.

In some embodiments, obtaining data and information may comply with laws and regulations of the country where it is located.

In some embodiments, the data and the information may be obtained after obtaining consent of the user.

Furthermore, each element, each row, or each column in tables of the embodiments of the present disclosure may be implemented as an independent embodiment, and any combination of elements, rows, or columns may also be implemented as an independent embodiment.

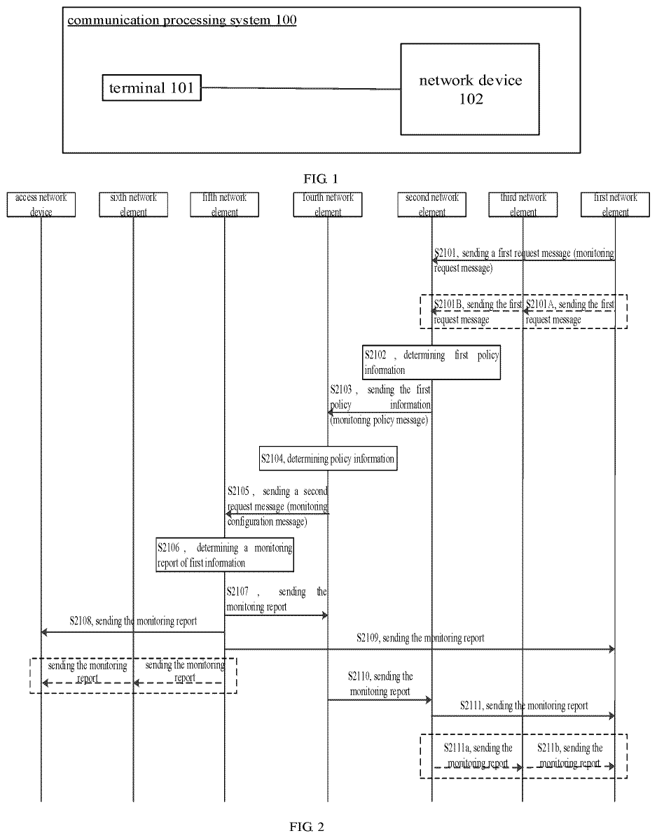

FIG. 1 is a schematic diagram of a structure of an information processing system 100 according to an embodiment of the present disclosure. As shown in FIG. 1, the information processing system 100 may include a terminal 101 and a network device 102.

In some embodiments, the network device 102 may include at least one of an access network device or a core network device.

In some embodiments, the terminal 101 includes, for example, at least one of a mobile phone, a wearable device, an Internet of Things device, a car having a communication capability, a smart car, a Pad, a computer with a wireless transceiving function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in a transportation safety, a wireless terminal in a smart city, or a wireless terminal in a smart home, etc., which is not limited to these.

In some embodiments, the access network device is, for example, a node or device that connects the terminal to a wireless network. The access network device may include at least one of an evolved NodeB (eNB) in a 5G communication system, a next generation eNB (ng-eNB), a next generation NodeB (gNB), a node B (NB), a home node B (HNB), a home evolved nodeB (HeNB), a wireless backhaul device, a radio network controller (RNC), a base station controller (BSC), a base transceiver station (BTS), a baseband unit (BBU), a mobile switching center, a base station in a 6G communication system, an Open RAN, a Cloud RAN, a base station in another communication system, or an access node in a wireless fidelity (Wi-Fi) system, which is not limited to these.

In some embodiments, the technical solution of the present disclosure may be applied to an Open RAN architecture. In this case, interfaces between access network devices or within the access network device in the embodiments of the present disclosure may become internal interfaces of the Open RAN, and flow and information interaction between these internal interfaces may be implemented via software or programs.

In some embodiments, the access network device may be composed of a central unit (CU) and distributed units (DUs). The CU may also be referred to as a control unit. The use of CU-DU structure allows to divide a protocol layer of the access network device, such that some of the protocol layer functions are placed in the CU for centralized control, and some or all of the remaining protocol layer functions are distributed in the DUs, and the DUs are centrally controlled by the CU, which is not limited to these.

In some embodiments, the core network device may be a device including network elements such as a first network element, a second network element, a fourth network element, a fifth network element, and/or a sixth network element, or may include a plurality of devices or device groups, each of which includes all or part of the above network elements. The network elements may be virtual or physical. The core network includes, for example, at least one of an evolved packet core (EPC), a 5G core network (5GCN), or a next generation core (NGC).

In some embodiments, the network device may also include a third-party network element besides the core network device, for example, a first network element. The first network element may be an AF, whose name is not limited to AF.

In some embodiments, the first network element is configured to request and/or manage an application.

In some embodiments, the second network element may be a PCF, whose name is not limited to PCF.

In some embodiments, the second network element is configured to provide a policy and charging rule.

In some embodiments, the third network element may be an NEF, whose name is not limited to NEF.

In some embodiments, the third network element is used for an NEF capability, for example, used for converting internal and external information.

In some embodiments, the fourth network element may be an SMF, whose name is not limited to SMF.

In some embodiments, the fourth network element is used for session management.

In some embodiments, the fifth network element may be a UPF, whose name is not limited to UPF.

In some embodiments, the fifth network element is used for user plane functions, such as packet routing and forwarding and/or policy enforcement, etc.

In some embodiments, the sixth network element may be an AMF, whose name is not limited to AMF.

In some embodiments, the sixth network element is used for registration, connection and/or mobility management, etc.

It may be understood that the communication system in the embodiments of the present disclosure is to clearly illustrate the technical solution of the embodiments of the present disclosure, and does not constitute a limitation on the technical solution in the embodiments of the present disclosure. Those skilled in the art may know, with evolution of the system architecture and emergence of new service scenarios, the technical solution in the embodiments of the disclosure is also applicable to similar technical problems.

The following embodiments of the present disclosure may be applied to the information processing system 100 shown in FIG. 1, or to some entities, which is not limited to these. Entities in FIG. 1 are illustrative. The information processing system may include all or some of the entities in FIG. 1, or may include other entities not shown in FIG. 1. The entities may be in any number and in any form. Connection relationships between the entities are illustrative. The entities may be not connected or may be connected, and the connection may be in any manner, for example, they may be directly connected or indirectly connected, or may be connected in a wired or wireless manner.

The embodiments of the present disclosure may be applied to long term evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), future radio access (FRA), new-radio access technology (RAT), new radio (NR), new radio access (NX), future generation radio access (FX), global system for mobile communications (GSM (registered trademark)), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), public land mobile network (PLMN), device-to-device (D2D) system, machine to machine (M2M) system, Internet of Things (IOT) system, Vehicle-to-Everything (V2X), systems using other communication methods, next-generation systems based on them, etc. In addition, a combination of a plurality of systems (e.g., a combination of LTE or LTE-A with 5G) may be applied.

In some embodiments, a mobile media service, an extended reality (XR) service such as augmented reality (AR) or virtual reality (VR), a cloud gaming service, and a video-based robot or drone remote control service will contribute increasingly higher traffic to the 5th generation mobile communication technology (5G) network. These services may involve a multi-modal data flow. The multi-modal data flow describes data for a same service or application, input from a same device or different devices (including sensors, etc.), and the data may be output to one or more destination devices. Various data flows within multi-modal data often have a certain or even strong correlation, such as synchronization of audio and video streams, or synchronization of haptic data and visual data, etc. Data flows of such media services themselves, relationships between these data flows, and network transmission requirements of these service data flows (SDFs) all share some common characteristics. Effectively identifying and using these characteristics will be more beneficial for transmission and control of networks and services, and also more beneficial for service assurance and user experience.

In some embodiments, characteristics of an XRM service require the 5G system (5GS) to comprehensively consider QoS characteristics of a relevant data flow of the service, for example, considering whether parameters such as a delay critical guaranteed bit rate (GBR), a guaranteed flow bit rate (GFBR), a packet delay budget (PDB), and/or a maximum data burst volume (MDBV) may be simultaneously met and coordinated consistently. This involves ensuring consistency in QoS authorization and execution for a plurality of XRM data flows of one UE, and XRM data flows of a plurality of UEs. Typically, the UE is a terminal.

In some embodiments, functional enhancement is supported for the AF for processing each packet data unit (PDU) set of the XRM service data flow, so as to support enhancement of QoS awareness and assurance of the XRM service data flow by the AF, and enhancement of the QoE of the user.

Optionally, the AF provides a PDU set specific QoS characteristics and protocol description. The QoS characteristics and protocol description includes at least one of: PDU set specific QoS characteristics, a PDU set delay budget (PSDB), a PDU set error rate (PSER), or PDU set integrated handling information (PSIHI).

In some embodiments, the SMF and the UPF can, in combination with the protocol description and protocol header extension provided by the AF, perform GTP-U header extension for a corresponding PDU in a corresponding service data flow (SDF) set. The GTP-U header extension may carry PDU set information. Optionally, the 5G NG radio access network (NG-RAN) performs PDU set based QoS processing using the PDU set information. Optionally, the PDU set information includes at least one of: PDU set sequence number; an indication of an end PDU of the PDU set; a PDU sequence number within the PDU set; a PDU set size in bytes; or PDU set importance, which identifies relative importance of the PDU set compared to other PDU sets within a QoS flow.

FIG. 2 is a schematic diagram of an interaction of an information processing method according to an embodiment of the present disclosure. As shown in FIG. 2, the embodiment of the present disclosure relates to an information processing method applied in an information processing system 100. The above method includes steps S2101 to S2111.

At step S2101, the first network element sends a first request message to a second network element.

In some embodiments, the second network element receives the first request message sent by the first network element.

In some embodiments, the first network element sends the first request message to the second network element via a third network element. Optionally, the second network element receives the first request message sent by the first network element via the third network element.

Optionally, the first network element sends the first request message to the third network element, and the third network element sends the first request message to the second network element.

Optionally, the first network element sends the first request message to the third network element. If the third network element determines that the first network element is a trusted first network element, the third network element sends the first request message to the second network element.

Optionally, the first network element sends the first request message to the third network element. If the third network element determines that the first network element is an untrusted first network element, the third network element does not send the first request message to the second network element.

Optionally, the first network element sends the first request message to the third network element. After receiving the first request message, the third network element determines the second network element and sends the first request message to the second network element.

In some embodiments, step S2101 includes steps S2101a to S2101b. At S2101a, the first network element sends the first request message to the third network element. At S2101b, the third network element sends the first request message to the second network element.

In some embodiments, the first network element sends the first request message to the second network element in an AF session establishment procedure. Optionally, the second network element receives the first request message sent by the first network element in the session establishment procedure.

In some embodiments, the first network element sends the first request message to the second network element in an AF session modification procedure. Optionally, the second network element receives the first request message sent by the first network element in the session modification procedure. Optionally, the AF session modification procedure may be an AF session update procedure.

In some embodiments, the first request message is configured to request first information of QoS monitoring. Optionally, the first request message is configured to request first information of the QoS monitoring performed by the fifth network element. Optionally, the QoS monitoring is monitoring a QoS. For example, the QoS monitoring may include at least one of: monitoring the first information, monitoring a QoS parameter, monitoring a packet delay, monitoring network congestion, and monitoring a power of the terminal. For example, the QoS parameter may include at least one of: a PDU set error rate, a PDU set delay budget, and/or a PDU set integrated indication.

In some embodiments, the first request message is configured for the second network element to determine first policy information.

In some embodiments, the first request message is configured for the fourth network element to determine a second request message.

In some embodiments, the first request message is configured to request a monitoring report of the first information. Optionally, the monitoring report of the first information may be one of: a parameter value corresponding to the TTNB; and a parameter value corresponding to the TTNB and parameter values of two burst times. Optionally, the parameter value corresponding to the TTNB is a parameter value corresponding to an inter burst time. Optionally, the monitoring report may include at least one monitoring result. The monitoring result may include at least one of the above parameter values.

In some embodiments, a name of the first request message is not limited, for example, it may be a monitoring request message, etc.

In some embodiments, the first request message may include the first information.

In some embodiments, a name of the first information is not limited, for example, it may be a TTNB, or burst time information, etc.

In some embodiments, the first information includes at least one of: a first time interval; or a first time interval and a second time interval. Optionally, the first time interval indicates an interval or a time period from a start time of a previous burst to a start time of a next burst among two bursts. Optionally, the second time interval indicates an interval or a time period between start times of two bursts.

In some embodiments, the first information may indicate one of: a TTNB, and a time interval between starts of two bursts. Optionally, the TTNB may be an inter burst time.

Optionally, both the TTNB or the inter burst time may be: an interval or a time period from an end time of a previous burst to a start time of a next burst. For example, if a start time of the first burst is 0 millisecond and a transmission time of the first burst is 1 millisecond, an end time of the first burst is the 1st millisecond; if a start time of the second burst is the 5th millisecond, a time to the next burst is the 5th millisecond or an inter burst time between the two bursts is 4 milliseconds. The TTNB or the inter burst time may be 4 milliseconds.

Optionally, the time interval between starts of the two bursts may be: an interval or a time period between a start time of a previous burst and a start time of a next burst. For example, if a start time of the first burst is O millisecond and a start time of the second burst is the 5th millisecond, a time period between starts of the two bursts is 5 milliseconds. The time interval between starts of the two bursts or the second time interval may be 5 milliseconds.

Optionally, the TTNB may be the first time interval in the previous embodiments; and/or, the time interval between starts of the two bursts may be the second time interval in the previous embodiments.

Optionally, the TTNB, the inter burst time, and the time period between starts of the two bursts may all refer to any two bursts.

Optionally, the first information may include the TTNB. Optionally, the first information may include the TTNB or the time interval between starts of the two bursts.

At step S2102, the second network element determines first policy information.

In some embodiments, the second network element determines the first policy information based on the first request message. Optionally, if the second network element receives the first request message, the second network element determines the first policy information. Optionally, if the second network element receives the first request message, the second network element generates authorized first policy information for an SDF.

In some embodiments, the first policy information indicates a policy of the QoS monitoring. Optionally, the first policy information may include at least one of or may indicate at least one piece of: first indication information, second indication information, third indication information, and fourth indication information.

In some embodiments, the first indication information, the second indication information, the third indication information, and the fourth indication information may each be one or more bits.

In some embodiments, a name of the first policy information is not limited, for example, it may be monitoring policy information, a QoS monitoring policy, etc.

In some embodiments, the first indication information indicates a monitoring object of the QoS monitoring. Optionally, the monitoring object may include the TTNB. Optionally, the monitoring object may include the TTNB and the time interval between starts of the two bursts. Optionally, the monitoring object may include at least one of: the TTNB, a QoS parameter, a delay, a network congestion situation, and a power of the terminal, etc.

Optionally, when the first indication information takes different values, it may indicate different monitoring objects. For example, when the first indication information takes a first value, such as “0” or “00”, etc., it is used to indicate that the monitoring object is the TTNB; or, when the first indication information takes a second value, such as “1” or “11”, etc., it is used to indicate that the monitoring object is the TTNB and the time interval between starts of the two bursts; or, when the first indication information takes a third value, such as “10”, it is used to indicate that the monitoring object is the delay.

In some embodiments, a name of the first indication information is not limited, for example, it may be monitoring object information, etc.

In some embodiments, the second indication information indicates a period for reporting a monitoring report of the first information. Optionally, the period may be a period for each newly measured monitoring report of the first information. Optionally, the period may be a period for a monitoring report that includes at least one monitoring report. Optionally, the period may be a predetermined time interval. The predetermined time interval may be specified by a protocol or configured by a device such as an access network device.

Optionally, when the second indication information takes different values, it may indicate different periods.

In some embodiments, a name of the second indication information is not limited, for example, it may be monitoring period information, etc.

In some embodiments, the third indication information indicates a reporting type for reporting the monitoring report of the first information, in which the reporting type includes: a periodic reporting type or an event triggered reporting type. Optionally, the periodic reporting type means: reporting according to a predetermined time interval. Optionally, the event triggered reporting type means: reporting when a trigger event is satisfied. Optionally, the trigger event may be one of: a timer reaching a set time, a time interval between two reporting being greater than or equal to a predetermined threshold, a current network signal strength being greater than or equal to a predetermined threshold, or bits of the data flow being greater than or equal to a predetermined bit size.

Optionally, when the third indication information takes different values, it may indicate different reporting types. For example, when the third indication information takes a first value, such as “0” or “00”, etc., it is used to indicate that the reporting type is the periodic reporting type; or, when the third indication information takes a second value, such as “1” or “11”, etc., it is used to indicate that the reporting type is the event triggered reporting type.

In some embodiments, a name of the third indication information is not limited, for example, it may be monitoring reporting type information, etc.

In some embodiments, the fourth indication information indicates a target object to which a monitoring report of the first information is reported. Optionally, the target object includes at least one of: an access network device, a first network element, a second network element, a third network element, or the fourth network element.

Optionally, when the fourth indication information takes different values, it may indicate different target objects. For example, when the fourth indication information takes a first value, such as “000”, etc., it is used to indicate that the target object is the access network device; or, when the fourth indication information takes a second value, such as “001”, etc., it is used to indicate that the target object is the first network element; or, when the fourth indication information takes a third value, such as “010”, etc., it is used to indicate that the target object is the second network element; or, when the fourth indication information takes a fourth value, such as “011”, etc., it is used to indicate that the target object is the third network element; or, when the fourth indication information takes a fifth value, such as “100”, etc., it is used to indicate that the target object is the fourth network element.

In some embodiments, a name of the fourth indication information is not limited, for example, it may be target object information, etc.

At step S2103, the second network element sends the first policy information to a fourth network element.

In some embodiments, the fourth network element receives the first policy information sent by the second network element.

In some embodiments, the second network element sends PCC rule information to the fourth network element. Optionally, the PCC rule information includes the first policy information.

In some embodiments, the fourth network element receives the PCC rule information sent by the second network element.

In some embodiments, the PCC rule information indicates at least one of: a charging rule of a data flow, a scheduling rule of a data flow, and a decision on network congestion, etc. Optionally, the PCC rule information may include a QoS parameter, etc.

In some embodiments, a name of the PCC rule information is not limited, for example, the PCC rule information may be information carrying the first policy information, etc.

At step S2104, the fourth network element determines policy information.

Optionally, the policy information may include at least one of: first policy information and second policy information.

In some embodiments, the fourth network element receives the first policy information sent by the second network element.

In some embodiments, the fourth network element determines the second policy information. Optionally, the fourth network element determines the second policy information based on at least one of the first policy information or local configuration information.

In some embodiments, the local configuration information may include operator policy information, etc. Optionally, the operator policy information may indicate a policy of at least one operator for QoS monitoring. Optionally, the local configuration information may include any one or more strategies for QoS monitoring stored locally, which is not limited here.

Optionally, the policy information indicates a policy of the QoS monitoring.

Optionally, the policy information may include at least one of or indicate at least one of: first indication information, second indication information, third indication information, or fourth indication information. For example, the second policy information may include at least one of: the first indication information, the second indication information, the third indication information, or the fourth indication information.

Optionally, the first policy information and the second policy information are at least partially the same. For example, content included in the first policy information and content included in the second policy information are entirely the same or partially the same.

Optionally, the first policy information and the second policy information are different.

Optionally, the first policy information is for at least one access network device; and the second policy information is for an access network device where the fourth network element is located.

At step S2105, the fourth network element sends a second request message to a fifth network element.

In some embodiments, the fifth network element receives the second request message sent by the fourth network element.

In some embodiments, the second request message indicates the QoS monitoring. Optionally, the second request message indicates the fifth network element to perform the QoS monitoring. Optionally, the second request message may be configuration information.

In some embodiments, the second request message is configured to request the first information of the QoS monitoring. Optionally, the second request message is configured to request the first information of the QoS monitoring performed by the fifth network element. Optionally, the second request message is configured to request a monitoring report of the first information.

Optionally, the monitoring report may be generated from a monitoring result. Optionally, the monitoring report includes at least one monitoring result.

Optionally, the second request message is determined based on the first request message.

In some embodiments, a name of the second request message is not limited, for example, it may be monitoring configuration information or a monitoring request message, etc.

In some embodiments, the second request message may include the first information.

In some embodiments, the second request message may include fifth indication information, in which the fifth indication information indicates the fifth network element to perform the QoS monitoring.

In some embodiments, the second request message includes policy information. Optionally, the second request message may include the first policy information. Optionally, the second request message may include the second policy information.

At step S2106, the fifth network element determines a monitoring report of the first information.

In some embodiments, the fifth network element obtains the monitoring report of the first information by performing the QoS monitoring based on the second request message.

In some embodiments, the fifth network element obtains the monitoring report of the first information by performing the QoS monitoring based on the policy information.

In some embodiments, a name of the monitoring report is not limited, for example, it may be a parameter value, a monitoring report, or a measurement result, etc.

In some embodiments, the monitoring report may include at least one of: a parameter value of the TTNB, parameter values of the two burst times, a parameter value of an inter burst time, or a monitoring report including at least one of the above parameter values, etc.

In some embodiments, the fifth network element determines the monitoring result based on the second request message. Optionally, the fifth network element sends the monitoring result to the fourth network element; the fourth network element sends the monitoring result to the second network element; and the second network element generates a monitoring report based on the monitoring result.

At step S2107, the fifth network element sends the monitoring report to the fourth network element.

In some embodiments, the fourth network element receives the monitoring report sent by the fifth network element.

In some embodiments, the fifth network element sends the first information and the monitoring report of the first information to the fourth network element.

At step S2108, the fifth network element sends the monitoring report to an access network device.

In some embodiments, the access network device receives the monitoring report sent by the fifth network element.

In some embodiments, the fifth network element sends the first information and the monitoring report of the first information to the access network device.

Optionally, the fifth network element directly sends the monitoring report to an access network device.

Optionally, the fifth network element sends the monitoring report to the access network device via a data packet of a GTP-U. For example, the fifth network element sends the data packet of the GTP-U to the access network device, in which the data packet of the GTP-U includes the monitoring report.

Optionally, the monitoring report is used for the access network device to configure the power for the terminal. Optionally, the monitoring report is used for CDRX configuration or DRX configuration of the access network device.

At step S2109, the fifth network element sends the monitoring report to the first network element.

In some embodiments, the first network element receives the monitoring report sent by the fifth network element.

In some embodiments, the fifth network element sends the first information and the monitoring report of the first information to the first network element.

Optionally, the fifth network element directly sends the monitoring report to the first network element.

Optionally, the fifth network element sends the monitoring report to the first network element via a third network element. Optionally, the fifth network element sends the monitoring report to the third network element, and the third network element sends the monitoring report to the first network element. Optionally, the first network element receives the monitoring report sent by the fifth network element via the third network element.

At step S2110, the fourth network element sends the monitoring report to the second network element.

In some embodiments, the second network element receives the monitoring report sent by the fourth network element.

Optionally, the fourth network element sends the first information and the monitoring report of the first information to the second network element.

In some embodiments, the fourth network element sends the monitoring report to an access network device via a sixth network element. Optionally, the fourth network element sends the monitoring report to the sixth network element, and the sixth network element sends the monitoring report to the access network device. Optionally, the access network device receives the monitoring report sent by the fourth network element via the sixth network element.

In some embodiments, the fourth network element sends the monitoring report to the access network device via an NGAP message. Optionally, the fourth network element sends the NGAP message, in which the NGAP message includes the monitoring report.

In some embodiments, the fourth network element sends the monitoring report to the first network element. Optionally, the first network element receives the monitoring report sent by the fourth network element.

In some embodiments, the fourth network element sends the monitoring report to the third network element via the second network element. Optionally, the third network element receives the monitoring report sent by the fourth network element via the second network element. Optionally, the fourth network element sends the monitoring report to the second network element, and the second network element sends the monitoring report to the third network element.

Optionally, the monitoring report is used for the second network element to determine a PCC rule.

At step S2111, the second network element sends the monitoring report to the first network element.

In some embodiments, the first network element receives the monitoring report sent by the second network element.

Optionally, the second network element sends the first information and the monitoring report of the first information to the first network element.

Optionally, the second network element directly sends the monitoring report to the first network element.

Optionally, the second network element sends the monitoring report to the first network element via the third network element. Optionally, the second network element sends the monitoring report to the third network element, and the third network element sends the monitoring report to the first network element.

In some embodiments, step S2111 includes step S2111a. At S2111a, the second network element sends the monitoring report to the third network element, and the third network element sends the monitoring report to the first network element.

The transmission of the monitoring report in the above steps S2101 to S2111 may include at least one of:

Method 1: The fifth network element sends the monitoring report to the fourth network element; the fourth network element sends the monitoring report to the second network element; the second network element sends the monitoring report to the third network element; and the third network element sends the monitoring report to the first network element.

Method 2: The fifth network element sends the monitoring report to the fourth network element; the fourth network element sends the monitoring report to the second network element; and second network element sends the monitoring report to the first network element.

Method 3: The fifth network element sends the monitoring report to the fourth network element; the fourth network element sends the monitoring report to the sixth network element; and the sixth network element sends the monitoring report to the access network device.

Method 4: The fifth network element sends the monitoring report to the access network device.

Method 5: The fifth network element sends the monitoring report to the first network element.

Method 6: The fifth network element sends the monitoring report to the third network element; and the third network element sends the monitoring report to the first network element.

In some embodiments, if the fifth network element receives a subscription request from the first network element, the fifth network element sends the monitoring report to the first network element. Optionally, the subscription request may be the first request message in the above embodiments.

In some embodiments, the first network element is an AF; and/or the second network element is a PCF; and/or the third network element is an NEF; and/or the fourth network element is an SMF; and/or the fifth network element is a UPF; and/or the sixth network element is an AMF.

In some embodiments, “obtain”, “acquire”, “get”, “receive”, “transmit”, “send and/or receive” may be used interchangeably, and they may be interpreted as receiving from another entity, obtaining from a protocol, obtaining by their own processing, autonomous implementation, and other meanings.

In some embodiments, terms such as “send”, “transmit”, “report”, “deliver”, “bidirectional transmission”, “send and/or receive”, etc., may be used interchangeably.

In some embodiments, terms such as “certain”, “preseted”, “preset”, “set”, “indicated”, “a/an”, “any”, “first”, etc., may be used interchangeably. “The A”, “predetermined A”, “preseted A”, “preset A”, “indicated A”, “a/an A”, “any A”, “first A” may be interpreted as A predefined in a protocol, etc., or as A obtained via setting, configuration, or indication, etc., or as the A, a/an A, any A, or first A, etc., which is not limited here.

In some embodiments, judging or determining may be performed using a value represented by 1 bit (0 or 1), or by a true value or a false value represented by true or false (boolean), or by numerical comparison (e.g., comparison with a predetermined value), which is not limited here.

In some embodiments, “does not expect to receive” may be interpreted as not receiving on a time-domain resource and/or a frequency-domain resource, or as not performing subsequent processing on data after receiving the data; and “does not expect to send” may be interpreted as not sending, or as sending but not expecting a receiver to respond to content that is sent.

The information processing method involved in the embodiments of the present disclosure may include at least one of steps S2101 to S2111. For example, S2101 may be implemented as an independent embodiment; S2102 may be implemented as an independent embodiment; S2104 may be implemented as an independent embodiment; S2105 may be implemented as an independent embodiment; S2106 may be implemented as an independent embodiment; a combination of S2106 and S2107 may be implemented as an independent embodiment; a combination of S2105 and S2106 and S2107 may be implemented as an independent embodiment; a combination of S2105 and S2106 and S2107 and S2110 and S2111 may be implemented as an independent embodiment; a combination of S2105 and S2106 and S2108 may be implemented as an independent embodiment; a combination of S2105 and S2106 and S2109 may be implemented as an independent embodiment; a combination of S2104 and S2105 and S2106 and S2107 and S2110 and S2111 may be implemented as an independent embodiment; a combination of S2104 and S2105 and S2106 and S2108 may be implemented as an independent embodiment; a combination of S2104 and S2105 and S2106 and S2109 may be implemented as an independent embodiment; a combination of S2102 and S2103 and S2104 and S2105 and S2106 and S2107 and S2110 and S2111 may be implemented as an independent embodiment; a combination of S2102 and S2103 and S2104 and S2105 and S2106 and S2108 may be implemented as an independent embodiment; a combination of S2102 and S2103 and S2104 and S2105 and S2106 and S2109 may be implemented as an independent embodiment; a combination of S2101 and S2102 and S2103 and S2104 and S2105 and S2106 and S2107 and S2110 and S2111 may be implemented as an independent embodiment; a combination of S2101 and S2102 and S2103 and S2104 and S2105 and S2106 and S2108 may be implemented as an independent embodiment; a combination of S2101 and S2102 and S2103 and S2104 and S2105 and S2106 and S2109 may be implemented as an independent embodiment; and a combination of S2101 to S2111 may be implemented as an independent embodiment.

In some embodiments, S2102 and S2104 may be exchanged in order or executed simultaneously; S2107, S2108, and S2109 may be exchanged in order or executed simultaneously; S2110, S2108, and S2109 may be exchanged in order or executed simultaneously; and S2111, S2108, and S2109 may be exchanged in order or executed simultaneously.

In some embodiments, at least one of S2101 to S2104, S2108, or S2109 may be omitted.

In some embodiments, at least one of S2101 to S2104, S2106, or S2109 to S2111 may be omitted.

In some embodiments, S2101 to S2104 may be optional, and in different embodiments, one or more of these steps may be omitted or substituted.

In some embodiments, S2108 and S2109 may be optional, and in different embodiments, one or more of these steps may be omitted or substituted.

In some embodiments, S2106, and S2109 to S2111 may be optional, and in different embodiments, one or more of these steps may be omitted or substituted.

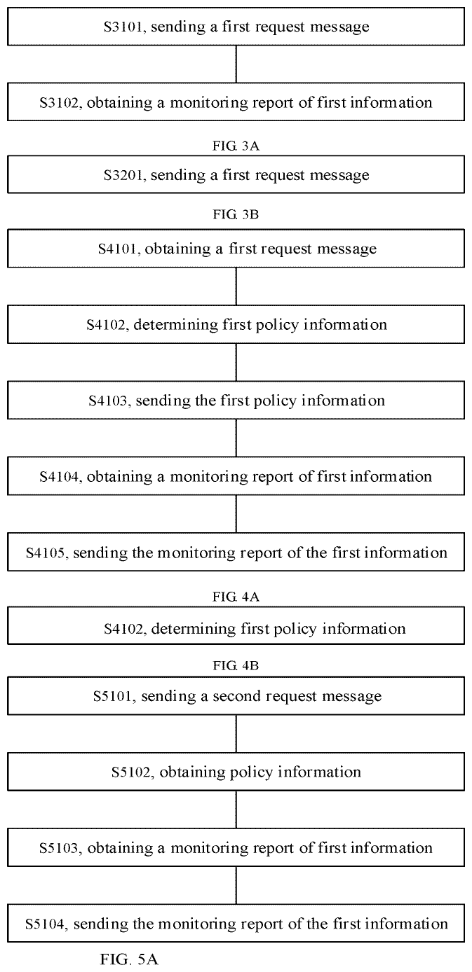

FIG. 3A is a flowchart of an information processing method according to an embodiment of the present disclosure. As shown in FIG. 3A, the embodiment of the present disclosure relates to an information processing method, performed by a first network element. The method includes steps S3101 to S3102.

At step S3101, a first request message is sent.

For optional implementations of step S3101, reference may be made to the optional implementations of step S2101 in FIG. 2 and other related parts in the embodiment related to FIG. 2, which will not be repeated here.

In some embodiments, the first network element sends the first request message to a second network element, but is not limited thereto, and may also send the first request message to other entities. Optionally, the first network element sends the first request message to a third network element.

In some embodiments, the first request message is configured for the second network element to determine first policy information.

In some embodiments, the first request message is configured for a fourth network element to determine a second request message.

In some embodiments, the first request message is configured to request a monitoring report of first information.

In some embodiments, the first request message may be an AF request message or a subscription message.

At step S3102, a monitoring report of first information is obtained.

For optional implementations of step S3102, reference may be made to the optional implementations of step S2111 in FIG. 2 and other related parts in the embodiments related to FIG. 2, which will not be repeated here.

In some embodiments, the first network element receives the monitoring report of the first information sent by the second network element, but is not limited thereto, and may also receive the monitoring report of the first information sent by other entities. Optionally, the first network element receives the monitoring report of the first information sent by a fifth network element. Optionally, the first network element receives the monitoring report of the first information sent by the third network element.

In some embodiments, the first network element obtains the monitoring report of the first information specified by a protocol.

In some embodiments, the first network element obtains the monitoring report of the first information from a higher layer.

In some embodiments, the first network element obtains the monitoring report of the first information by performing processing.

In some embodiments, step S3102 is omitted, and the first network element autonomously implements a function indicated by the monitoring report of the first information, or the above function is default.

The information processing method involved in the embodiments of the present disclosure may include at least one of S3101 to S3102. For example, S3101 may be implemented as an independent embodiment, and a combination of S3106 and S3102 may be implemented as an independent embodiment.

In some embodiments, S3101 may be optional or S3102 may be optional, and in different embodiments, one or more of these steps may be omitted or substituted.

FIG. 3B is a flowchart of an information processing method according to an embodiment of the present disclosure. As shown in FIG. 3B, the embodiment of the present disclosure relates to an information processing method, performed by a first network element. The method includes a step S3201.

At step S3201, a first request message is sent.

For optional implementations of S3201, reference may be made to the optional implementations of S2101 in FIG. 2 or S3101 in FIG. 3A, and other related parts in the embodiment related to FIG. 2 and FIG. 3A, which will not be repeated here.

Optionally, the first request message is configured to request first information of QoS monitoring; and the first information indicates one of: a TTNB; or a TTNB and a time interval between starts of two bursts.

In some embodiments, sending the first request message includes: sending the first request message in an AF session establishment procedure.

In some embodiments, sending the first request message includes: sending the first request message in an AF session modification procedure.

In some embodiments, sending the first request message includes: sending the first request message to a second network element.

In some embodiments, sending the first request message includes: sending the first request message to the second network element via a third network element.

In some embodiments, the method further includes one of: receiving a monitoring report of the first information sent by a second network element; or receiving a monitoring report of the first information sent by a second network element via a third network element.

In some embodiments, the first network element is an AF; and/or the second network element is a PCF; and/or the third network element is an NEF.

The above embodiments may be implemented independently or in combination with each other. For optional implementations, reference may be made to the optional implementations of the steps in FIG. 2 and FIG. 3A, which will not be repeated here.

FIG. 4A is a flowchart of an information processing method according to an embodiment of the present disclosure. As shown in FIG. 4A, the embodiment of the present disclosure relates to an information processing method, performed by a first network element. The above method includes steps S4101 to S4105.

At step S4101, a first request message is obtained.

For optional implementations of S4101, reference may be made to the optional implementations of S2101 in FIG. 2 and other related parts in the embodiments related to FIG. 2, which will not be repeated here.

In some embodiments, the second network element receives the first request message sent by the first network element, but is not limited thereto, and may also receive the first request message sent by other entities. Optionally, the second network element receives the first request message sent by a third network element.

In some embodiments, the second network element obtains the first request message specified by a protocol.

In some embodiments, the second network element obtains the first request message from a higher layer.

In some embodiments, the second network element obtains the first request message by performing processing.

In some embodiments, S4101 is omitted, and the second network element autonomously implements a function indicated by the first request message, or the above function is default.

At step S4102, first policy information is determined.

For optional implementations of S4102, reference may be made to the optional implementations of S2102 in FIG. 2 and other related parts in the embodiments related to FIG. 2, which will not be repeated here.

In some embodiments, the second network element determines the first policy information based on the first request message. Optionally, the first policy information is determined based on the first request message.

At step S4103, the first policy information is sent.

For optional implementations of S4103, reference may be made to the optional implementations of S2103 in FIG. 2 and other related parts in the embodiments related to FIG. 2, which will not be repeated here.

In some embodiments, the second network element sends the first request message to a fourth network element, but is not limited thereto, and may also send the first request message to other entities.

Optionally, the first policy information is configured for the fourth network element to determine a second request message.

Optionally, the first policy information is configured for a fifth network element to perform QoS monitoring. Optionally, the first policy information is configured for the fifth network element to perform the QoS monitoring to obtain the monitoring report of the first information.

At step S4104, a monitoring report of first information is obtained.

For optional implementations of S4104, reference may be made to the optional implementations of S2110 in FIG. 2 and other related parts in the embodiments related to FIG. 2, which will not be repeated here.

In some embodiments, the second network element receives the monitoring report of the first information sent by the fourth network element, but is not limited thereto, and may also receive the first information sent by other entities.

In some embodiments, the second network element obtains the monitoring report of the first information specified by a protocol.

In some embodiments, the second network element obtains the monitoring report of the first information from a higher layer.

In some embodiments, the second network element obtains the monitoring report of the first information by performing processing.

In some embodiments, S4104 is omitted, and the second network element autonomously implements a function indicated by the monitoring report of the first information, or the above function is default.

At step S4105, the monitoring report of the first information is sent.

For optional implementations of S4105, reference may be made to the optional implementations of S2111 in FIG. 2 and other related parts in the embodiments related to FIG. 2, which will not be repeated here.

In some embodiments, the second network element sends the monitoring report of the first information to the first network element, but is not limited thereto, and may also send the monitoring report of the first information to other entities.

The information processing method involved in the embodiments of the present disclosure may include at least one of S4101 to S4105. For example, S4102 may be implemented as an independent embodiment; a combination of S4102 and S4103 may be implemented as an independent embodiment; a combination of S4102 and S4103 and S4104 may be implemented as an independent embodiment; a combination of S4102 and S4103 and S4104 and S4105 may be implemented as an independent embodiment; and a combination of S4101 to S4105 may be implemented as an independent embodiment.

In some embodiments, at least one of S4101, S4104, or S4105 may be omitted.

In some embodiments, at least one of S4102 or S4103 may be omitted.

In some embodiments, S4101, S4104, and S4105 may be optional, and in different embodiments, one or more of these steps may be omitted or substituted.

In some embodiments, S4102 and S4103 may be optional, and in different embodiments, one or more of these steps may be omitted or substituted.

FIG. 4B is a flowchart of an information processing method according to an embodiment of the present disclosure. As shown in FIG. 4B, the embodiment of the present disclosure relates to an information processing method, performed by a second network element. The method includes a step S4102.

At step S4102, first policy information is determined.

For optional implementations of S4102, reference may be made to the optional implementations of S2101 in FIG. 2, or S4101 in FIG. 4A, and other related parts in the embodiments related to FIG. 2 and FIG. 4A, which will not be repeated here.

In some embodiments, the second network element obtains the first request message, in which the first request message is configured to request first information of QoS monitoring; and the first information indicates one of: a TTNB; or a TTNB and a time interval between starts of two bursts.

In some embodiments, the second network element, after obtaining the first request message, determines the first policy information.

In some embodiments, receiving the first request message includes one of: receiving the first request message sent by a first network element; or receiving the first request message sent by a first network element via a third network element.

In some embodiments, the method includes: determining, by the second network element, first policy information based on the first request message, in which the first policy information indicates a policy of the QoS monitoring; and sending the first policy information to a fourth network element.

In some embodiments, sending the first policy information to the fourth network element includes: sending PCC rule information to the fourth network element, in which the PCC rule information includes the first policy information.

In some embodiments, the method further includes: receiving, by the second network element, a monitoring report of the first information sent by a fourth network element; and sending, by the second network element, the monitoring report to a first network element, and/or sending the monitoring report to the first network element.

In some embodiments, the first network element is an AF; and/or the second network element is a PCF; and/or the third network element is an NEF; and/or the fourth network element is an SMF.

The above embodiments may be implemented independently or in combination with each other. For optional implementations, reference may be made to the optional implementations of the steps in FIG. 2 and FIG. 3A, which will not be repeated here.

FIG. 5A is a flowchart of an information processing method according to an embodiment of the present disclosure. As shown in FIG. 5A, the embodiment of the present disclosure relates to an information processing method, performed by a fourth network element. The above method includes steps S5101 to S5104.

At step S5101, a second request message is sent.

For optional implementations of S5101, reference may be made to the optional implementations of S2105 in FIG. 2 and other related parts in the embodiments related to FIG. 2, which will not be repeated here.

In some embodiments, the fourth network element sends the second request message to a fifth network element, but is not limited thereto, and may also send the second request message to other entities.

In some embodiments, the second request message indicates the fifth network element to perform QoS monitoring. Optionally, the second request message indicates the fifth network element to obtain a monitoring report of the first information by performing the QoS monitoring. Optionally, the second request is configured to obtain the monitoring report of the first information.

At step S5102, policy information is obtained.

For optional implementations of S5102, reference may be made to the optional implementations of S2104 in FIG. 2 and other related parts in the embodiments related to FIG. 2, which will not be repeated here.

In some embodiments, the policy information includes first policy information and/or second policy information.

In some embodiments, the fourth network element receives the first policy information sent by the second network element, but is not limited thereto, and may also receive the first policy information sent by other entities.

In some embodiments, the fourth network element determines second policy information.

In some embodiments, the fourth network element obtains the policy information specified by a protocol.

In some embodiments, the fourth network element obtains the policy information from a higher layer.

In some embodiments, the fourth network element obtains the policy information by performing processing.

In some embodiments, S5102 is omitted, and the first network element autonomously implements a function indicated by the policy information, or the above function is default.

At step S5103, a monitoring report of first information is obtained.

For optional implementations of S5103, reference may be made to the optional implementations of S2107 in FIG. 2 and other related parts in the embodiments related to FIG. 2, which will not be repeated here.

In some embodiments, the fourth network element receives the monitoring report of the first information sent by the fifth network element, but is not limited thereto, and may also receive the monitoring report of the first information sent by other entities.

In some embodiments, the fourth network element obtains the monitoring report of the first information specified by a protocol.

In some embodiments, the fourth network element obtains the monitoring report of the first information from a higher layer.

In some embodiments, the fourth network element obtains the monitoring report of the first information by performing processing.

In some embodiments, S5103 is omitted, and the fourth network element autonomously implements a function indicated by the monitoring report of the first information, or the above function is default.

At step S5104, the monitoring report of the first information is sent.

For optional implementations of S5104, reference may be made to the optional implementations of S2110 in FIG. 2 and other related parts in the embodiments related to FIG. 2, which will not be repeated here.

In some embodiments, the fourth network element sends the monitoring report of the first information to the second network element, but is not limited thereto, and may also send the monitoring report of the first information to other entities. Optionally, the fourth network element sends the monitoring report of the first information to a sixth network element.

The information processing method involved in the embodiments of the present disclosure may include at least one of S5101 to S5104. For example, S5101 may be implemented as an independent embodiment; S5102 may be implemented as an independent embodiment; a combination of S5101 and S5102 may be implemented as an independent embodiment; a combination of S5101 and S5102 and S5103 may be implemented as an independent embodiment; and a combination of S5101 to S5104 may be implemented as an independent embodiment.

In some embodiments, S5102 and S5102 may be exchanged in order or executed simultaneously.

In some embodiments, at least one of S5102, S5103, or S5104 may be omitted.

In some embodiments, S5101 and S5102 may be optional, and in different embodiments, one or more of these steps may be omitted or substituted.

FIG. 5B is a flowchart of an information processing method according to an embodiment of the present disclosure. As shown in FIG. 5B, the embodiments of the present disclosure relate to an information processing method, performed by a fourth network element. The method includes a step S5201.

At step S5201, a second request message is sent.

For optional implementations of S5201, reference may be made to the optional implementations of S2105 in FIG. 2 or S5101 in FIG. 5A, and other related parts in the embodiments related to FIG. 2 and FIG. 5A, which will not be repeated here.

In some embodiments, the second request message indicates QoS monitoring, and the second request message is configured to request first information of QoS monitoring; and the first information indicates one of: a TTNB; or a TTNB and a time interval between starts of two bursts.

In some embodiments, the second request message includes policy information, in which the policy information indicates a policy of the QoS monitoring.

In some embodiments, the policy information includes first policy information; and the method further includes: receiving the first policy information sent by a second network element.

In some embodiments, the policy information includes second policy information; and the method further includes: determining the second policy information based on at least one of the first policy information or local configuration information.

In some embodiments, the policy information includes at least one of: first indication information, indicating a monitoring object of the QoS monitoring; second indication information, indicating a period for reporting a monitoring report of the first information; third indication information, indicating a reporting type for reporting a monitoring report of the first information, in which the reporting type includes: a periodic reporting type or an event triggered reporting type; or fourth indication information, indicating a target object to which a monitoring report of the first information is reported, in which the target object includes at least one of: an access network device, a first network element, a second network element, a third network element (NEF), or the fourth network element (SMF).

In some embodiments, the method includes: receiving a monitoring report of the first information sent by the fifth network element.

In some embodiments, the method includes at least one of: sending the monitoring report to a second network element; sending the monitoring report to an access network device via a sixth network element; sending the monitoring report to an access network device via an NGAP message; sending the monitoring report to a first network element; or sending the monitoring report to a third network element via a second network element.

In some embodiments, the first network element is an AF; and/or the second network element is a PCF; and/or the third network element is an NEF; and/or the fourth network element is an SMF; and/or the fifth network element is a UPF; and/or the sixth network element is an AMF.

The above embodiments may be implemented independently or in combination with each other. For optional implementations, reference may be made to the optional implementations of steps in FIG. 2 and FIG. 5A, which will not be repeated here.

FIG. 5C is a flowchart of an information processing method according to an embodiment of the present disclosure. As shown in FIG. 5C, the embodiments of the present disclosure relate to an information processing method, performed by a fourth network element. The method includes a step S5301.

At step S5301, policy information is obtained.

For optional implementations of S5301, reference may be made to the optional implementations of S2104 in FIG. 2 or S5102 in FIG. 5A, and other related parts in the embodiments related to FIG. 2 and FIG. 5A, which will not be repeated here.

The above embodiments may be implemented independently or in combination with each other. For optional implementations, reference may be made to the optional implementations of steps in FIG. 2 and FIG. 5A, which will not be repeated here.

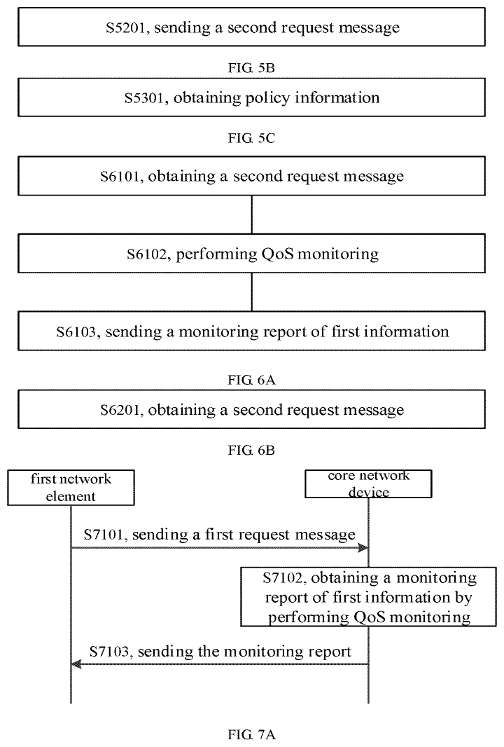

FIG. 6A is a flowchart of an information processing method according to an embodiment of the present disclosure. As shown in FIG. 6A, the embodiments of the present disclosure relate to an information processing method, performed by a fifth network element. The method includes steps S6101 to S6103.

At step S6101, a second request message is obtained.

For optional implementations of S6101, reference may be made to the optional implementations of S2105 in FIG. 2 and other related parts in the embodiments related to FIG. 2, which will not be repeated here.

In some embodiments, the fifth network element receives the second request message sent by the fourth network element, but is not limited thereto, and may also receive the second request message sent by other entities.

In some embodiments, the fifth network element obtains the second request message specified by a protocol.

In some embodiments, the fifth network element obtains the second request message from a higher layer.

In some embodiments, the fifth network element obtains the second request message by performing processing.

In some embodiments, S6101 is omitted, and the fifth network element autonomously implements a function indicated by the second request message, or the above function is default.

At step S6102, QoS monitoring is performed.

For optional implementations of S6102, reference may be made to the optional implementations of S2106 in FIG. 2 and other related parts in the embodiments related to FIG. 2, which will not be repeated here.

In some embodiments, the fifth network element obtains a monitoring report of first information by performing the QoS monitoring based on the second request message.

At step S6103, a monitoring report of first information is sent.

For optional implementations of S6103, reference may be made to the optional implementations of S2105 in FIG. 2 and other related parts in the embodiments related to FIG. 2, which will not be repeated here.

In some embodiments, the fifth network element sends the monitoring report of the first information to the fourth network element, but is not limited thereto, and may also send the monitoring report of the first information to other entities. Optionally, the fifth network element sends the monitoring report of the first information to the fourth network element. Optionally, the fifth network element sends the monitoring report of the first information to the access network device.

The information processing method involved in the embodiments of the present disclosure may include at least one of S6101 to S6103. For example, S6101 may be implemented as an independent embodiment; S6102 may be implemented as an independent embodiment; a combination of S6101 and S6102 may be implemented as an independent embodiment; and a combination of S6101 and S6102 and S6103 may be implemented as an independent embodiment.

In some embodiments, at least one of S6102 or S6103 may be omitted.

In some embodiments, S6102 and S6103 may be optional, and in different embodiments, one or more of these steps may be omitted or substituted.

FIG. 6B is a flowchart of an information processing method according to an embodiment of the present disclosure. As shown in FIG. 6B, the embodiments of the present disclosure relate to an information processing method, performed by a fifth network element. The above method includes a step S6201.

At step S6201, a second request message is obtained.

For optional implementations of S6201, reference may be made to the optional implementations of S2105 in FIG. 2 or S6101 in FIG. 6A, and other related parts in the embodiments related to FIG. 2 and FIG. 6A, which will not be repeated here.

In some embodiments, the second request message indicates QoS monitoring, and the second request message is configured to request first information of the QoS monitoring; and the first information indicates one of: a TTNB; or a TTNB and a time interval between starts of two bursts.

In some embodiments, the second request message includes policy information, and the policy information indicates a policy of the QoS monitoring.

In some embodiments, the policy information includes at least one of: first indication information, indicating a monitoring object of the QoS monitoring; second indication information, indicating a period for reporting a monitoring report of the first information; third indication information, indicating a reporting type for reporting a monitoring report of the first information, in which the reporting type includes: a periodic reporting type or an event triggered reporting type; or fourth indication information, indicating a target object to which a monitoring report of the first information is reported, in which the target object includes at least one of: an access network device, a first network element, a second network element, a third network element (NEF), or the fourth network element (SMF).

In some embodiments, the method includes: obtaining a monitoring report of the first information by performing the QoS monitoring based on the second request message.

In some embodiments, the method includes at least one of: sending the monitoring report to the fourth network element; sending the monitoring report to a first network element; sending the monitoring report to a third network element; or sending the monitoring report to an access network device via a data packet of a GTP-U.

In some embodiments, the first network element is an AF; and/or the third network element is an NEF; and/or the fourth network element is an SMF; and/or the fifth network element is a UPF.

The above embodiments may be implemented independently or in combination with each other. For optional implementations, reference may be made to the optional implementations of steps in FIG. 2 and FIG. 5A, which will not be repeated here.

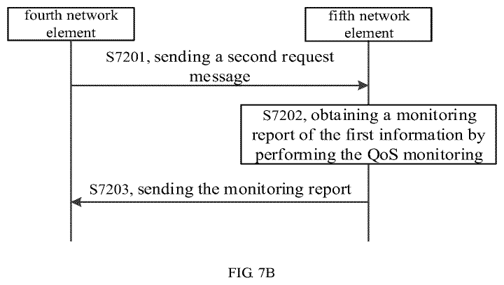

FIG. 7A is a flowchart of an information processing method according to an embodiment of the present disclosure. As shown in FIG. 7A, the embodiments of the present disclosure relate to an information processing method, performed by a communication system, in which the communication system includes a core network device and a first network element. The method includes steps S7101 to S7103.

At step S7101, the first network element sends a first request message to the core network device.

For optional implementations of S7101, reference may be made to the optional implementations of S2101 in FIG. 2, S3101 in FIG. 3A, and S4101 in FIG. 4A, and other related parts in the embodiments related to FIG. 2, FIG. 3A, and FIG. 4A, which will not be repeated here.

Optionally, the second request message is configured to request first information of the QoS monitoring; and the first information indicates at least one of: a TTNB; or a TTNB and a time interval between starts of two bursts.

At step S7102, the core network device obtains a monitoring report of first information by performing QoS monitoring.

For optional implementations of S7102, reference may be made to the optional implementations of S2106 in FIG. 2, S3102 in FIG. 3A, and S5103 in FIG. 5A, and other related parts in the embodiments related to FIG. 2, FIG. 3A, and FIG. 5A, which will not be repeated here.

At step S7103, the core network device sends the monitoring report to the first network element.

For optional implementations of S7103, reference may be made to the optional implementations of S2111 in FIG. 2 and S6103 in FIG. 6A, and other related parts in the embodiments related to FIG. 2 and FIG. 6A, which will not be repeated here.

In some embodiments, the above method may include the methods described in the embodiments on the information processing system 100 side, the first network element side, the second network element side, the third network element side, the fourth network element side, the fifth network element side, the sixth network element side, etc., which will not be repeated here.

FIG. 7B is a flowchart of an information processing method according to an embodiment of the present disclosure. As shown in FIG. 7B, the embodiments of the present disclosure relate to an information processing method, performed by a core network device, in which the core network device includes a fourth network element and a fifth network element. The method includes steps S7201 to S7203.

At step S7201, the fourth network element sends a second request message to the fifth network element.

For optional implementations of S7201, reference may be made to the optional implementations of S2105 in FIG. 2, S5101 in FIG. 4A, and S6101 in FIG. 5A, and other related parts in the embodiments related to FIG. 2, FIG. 4A, and FIG. 5A, which will not be repeated here.

Optionally, the second request message indicates QoS monitoring, and the second request message is configured to request first information of the QoS monitoring; and the first information indicates one of: a TTNB; or a TTNB and a time interval between starts of two bursts.

At step S7202, the fifth network element obtains a monitoring report of the first information by performing the QoS monitoring.

For optional implementations of S7202, reference may be made to the optional implementations of S2106 in FIG. 2, S3102 in FIG. 3A, and S5103 in FIG. 5A, and other related parts in the embodiments related to FIG. 2, FIG. 3A, and FIG. 5A, which will not be repeated here.

At step S7203, the fifth network element sends the monitoring report to the fourth network element.

For optional implementations of S7202, reference may be made to the optional implementations of S2107 in FIG. 2 and S6103 in FIG. 6A, and other related parts in the embodiments related to FIG. 2 and FIG. 6A, which will not be repeated here.

In some embodiments, the core network device further includes a second network element; and the method includes: sending, by the second network element, first policy information to the fourth network element, in which the first policy information indicates a policy of the QoS monitoring.

In some embodiments, the method further includes: determining second policy information based on at least one of the first policy information or local configuration information, in which the second policy information indicates the policy of the QoS monitoring.

In some embodiments, the above method may include the methods described in the embodiments on the information processing system 100 side, the first network element side, the second network element side, the third network element side, the fourth network element side, the fifth network element side, the sixth network element side, etc., which will not be repeated here.

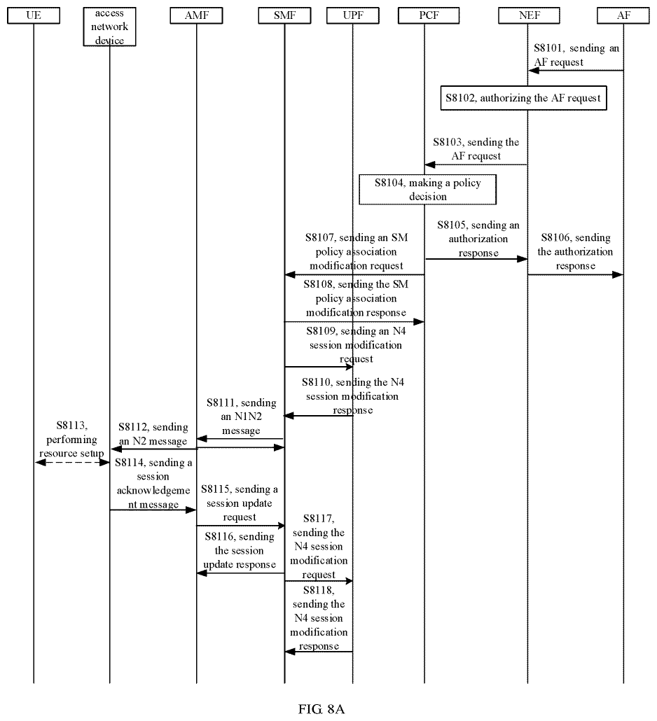

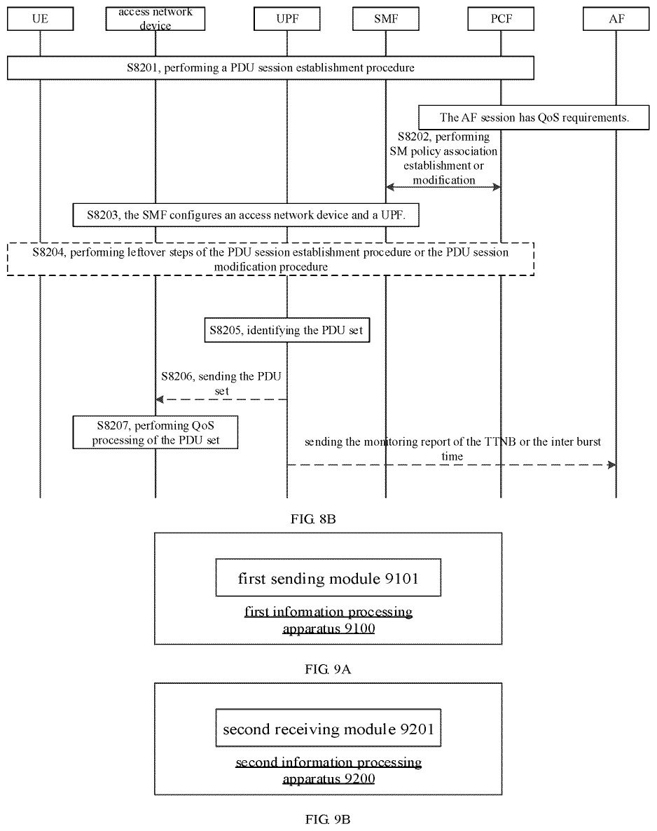

FIG. 8A is a flowchart of an information processing method according to an embodiment of the present disclosure. As shown in FIG. 8A, the embodiments of the present disclosure relate to an information processing method. The method includes steps S8101 to S8118.

At step S8101, an AF sends an AF request.

Optionally, the AF request includes a TTNB. Optionally, the AF request includes the TTNB and a time interval between starts of two bursts. Optionally, the AF request is the first request message in the embodiments.

Optionally, during an AF QoS request procedure or an AF QoS update procedure, the AF provides QoS monitoring requirements to an NEF or a PCF. The QoS monitoring requirements include the TTNB or an inter burst time. Optionally, the QoS monitoring requirements may be the first request message in the above embodiments.

Optionally, the AF request may be an AF session resource request. The AF creates the AF request via an Nnef_AFsessionWithQoS_Create request, and the AF carries QoS requirements for an XRM service and an interactive media SDF in the AF request.

Optionally, the AF request may also include XRM service information, in which the XRM service information may include at least one of: a multi-modal service ID, UE address information, a UE identifier, an AF identifier application ID, flow description(s), a data network name (DNN), single network slice selection assistance information (S-NSSAI), or a QoS parameter. Optionally, the multi-modal service ID is used to identify an XRM SDF or a data flow group. For example, the multi-modal service ID may be used to identify all data flows in an XRM service group.

At step S8102, the NEF authorizes the AF request.

Optionally, if the AF is an untrusted AF, the AF request sent by the AF may be provided to the PCF via the NEF.

Optionally, the NEF performs related mapping, including: mapping an XRM service identifier (for example, an AF-Service-Identifier) to the DNN and the S-NSSAI, mapping from an external application to a core network (CN) application identifier, unified data management (UDM) subscription information, mapping from an external UE identifier to an internal UE identifier in a CN (such as subscriber permanent identifier (SUPI)), and external-to-internal XRM service group identifier mapping according to UDM subscription information.

At step S8103, the NEF sends the AF request to the PCF.

Optionally, the NEF authorizes the AF request and determines whether to invoke a time sensitive communication and time synchronization function (TSCTSF) or directly contact the PCF based on a parameter provided by the AF. Optionally, the PCF receives characteristics provided by the AF from the NEF or the TSCTSF.

Optionally, the NEF triggers an Npcf_PolicyAuthorization_Create request to send the AF request to the PCF, in which the AF request carries QoS requirement information for the PCF to make a policy decision.

Optionally, the AF request carries QoS monitoring requirements of a corresponding SDF, for example, an inter burst time or a TTNB.

At step S8104, the PCF makes a policy decision.

Optionally, the PCF may determine that updated or new policy information is sent to the SMF. Optionally, the policy decision or the updated or new policy information may be the first policy information in the above embodiments.

Optionally, based on the QoS monitoring requirements received from the AF, the PCF generates an authorized QoS monitoring policy (TTNB) for a service data flow. The PCF includes the authorized QoS monitoring policy (TTNB) in a PCC rule and provides the PCC rule to the SMF. Optionally, the QoS monitoring policy may be the first request message in the above embodiments.

At step S8105, the PCF sends an authorization response to the NEF.

Optionally, the authorization response may be an Npcf_PolicyAuthorization_Create response, and the authorization response may indicate whether the policy decision made by the PCF is authorized.

At step S8106, the NEF sends the authorization response to the AF.

Optionally, the authorization response may be an Nnef_AFsessionWithQoS_Create response, and the authorization response may indicate whether the AF request is authorized.

At step S8107, the PCF sends an SM policy association modification request to the SMF.

Optionally, the SM policy association modification request may be an SM Policy Association Modification Request, and this update request includes the PCC rule. Optionally, the PCC rule may include the TTNB or the inter burst time.

Optionally, the SM policy association modification request may be the second request message in the above embodiments.

Optionally, when the SMF receives an authorized QoS monitoring policy for the inter burst time, the SMF configures the UPF to perform TTNB measurements.

Optionally, the SMF configures the UPF to perform a QoS monitoring policy (TTNB) for a QoS of a QoS flow, and the QoS monitoring policy may be determined by the SMF based on the authorized QoS monitoring policy received from the PCF and/or local configuration. Optionally, the QoS monitoring policy locally configured at the SMF may be the second policy information in the above embodiments.

At step S8108, the SMF sends the SM policy association modification response to the PCF.

Optionally, the SM policy association modification response may be an SM Policy Association Modification Response.

At step S8109, the SMF sends an N4 session modification request to the UPF.

Optionally, the N4 session modification request may be an N4 Session Modification Request, and the N4 session modification request includes the TTNB or the inter burst time.

Optionally, the N4 session modification request may include the monitoring report of the first information in the above embodiments.

Optionally, the SMF configures the UPF to perform (TTNB) QoS monitoring of a QoS flow and report the monitoring report, the monitoring report including: a QoS parameter to be measured indicating the subject of the QoS monitoring (for example, TTNB); a reporting period indicating the time interval in which a new measurement result and a potential report has to be available; a reporting frequency indicating the type of the reporting as “periodic” or “event triggered”; and a target of the reporting and an indication of a direct event notification indicating that the UPF shall send the report to a different NF than the SMF (for example, to the local NEF or the AF). Optionally, the report is the monitoring report in the above embodiments.

Optionally, the QoS parameter may be the first indication information in the above embodiments. Optionally, the new measurement result may be the monitoring report or monitoring result in the above embodiments. Optionally, the reporting period may be the second indication information in the above embodiments. The reporting frequency may be the third indication information in the above embodiments. The target of the reporting and the indication of the direct event notification may be the fourth indication information in the above embodiments.

At step S8110, the UPF sends the N4 session modification response to the SMF. Optionally, the UPF responds to the SMF.

Optionally, the N4 session modification response may be an N4 Session Modification Response, and the N4 session modification response includes the monitoring report of the TTNB or the inter burst time.

At step S8111, the SMF sends an N1N2 message to the AMF.

Optionally, the N1N2 message may be Namf_Communication_n1 N2 message transfer, and the N1N2 message includes the monitoring report of the TTNB or the inter burst time.

Optionally, for an SMF requested modification, the SMF invokes Namf_Communication_n1 N2 message transfer ([N2 SM information] (PDU session ID, QFI, QoS profile, N1 SM container)).

At step S8112, the AMF sends an N2 message to a radio access network (RAN) device.

Optionally, the AMF may send the N2 ([N2 SM information received from the SMF], a non-access stratum (NAS) message (PDU session ID, N1 SM container (PDU session modification command))) message to the RAN.

Optionally, after the RAN device receives the monitoring report of the TTNB or the inter burst time, the RAN device configures UE energy consumption management (for example, for DRX configuration).

At step S8113, resource setup is performed between the RAN device and the UE. The step S813 is optional.

At step S8114, the RAN device sends a session acknowledgement message to the AMF.

Optionally, the session acknowledgement message may be an N2 PDU session acknowledgement message, and the N2 PDU session acknowledgement message is used to acknowledge an N2 PDU session request.

At step S8115, the AMF sends a session update request to the SMF.

Optionally, the AMF forwards the N2 SM information received from the RAN device to the SMF via an Nsmf_PDUSession_UpdateSMContext service operation.

At step S8116, the SMF sends the session update response to the AMF.

Optionally, the SMF responds to the session update request using an Nsmf_PDUSession_UpdateSMContext Response (i.e., session update response).

At step S8117, the SMF sends the N4 session modification request to the UPF.

Optionally, the N4 session modification request may be N4 Session Modification Request.

At step S8118, the UPF sends the N4 session modification response to the SMF.

Optionally, the N4 session modification response may be N4 Session Modification Response.

In some embodiments, the UPF performs (TTNB) QOS monitoring and reports the monitoring report. The UPF reports a TTNB report to the SMF, to the NG-RAN, and/or reports to the local NEF or the AF. Optionally, the TTNB report may be the monitoring report in the above embodiments.

In some embodiments, after the SMF receives the TTNB report from the UPF, the SMF performs at least one of:
the SMF forwards the TTNB report to the NG-RAN (e.g. in an NGAP message), to configure UE power management (e.g. for DRX configuration); or
the SMF forwards the TTNB report to the PCF, to determinate the PCC rule, and/or, if the AF subscribes to the TTNB report, the SMF exposes/notifies the TTNB report to the AF.

The information processing method involved in the embodiments of the present disclosure may include at least one of S8101 to S8118. For example, S8108 may be implemented as an independent embodiment; a combination of S8107 and S8108 may be implemented as an independent embodiment; a combination of S8108 and S8109 may be implemented as an independent embodiment; a combination of S8107 and S8108 and S8109 may be implemented as an independent embodiment; a combination of S8101, S8103, S8107, S8108 and S8109 may be implemented as an independent embodiment; a combination of S8109 and S8110 may be implemented as an independent embodiment; a combination of S8109, S8110 and S8111 may be implemented as an independent embodiment; and a combination of S8109, S8110, S8111, and S81112 may be implemented as an independent embodiment.

In some embodiments, at least one of S8101 to S8106, and S8113 to S8118 may be omitted.

In some embodiments, S8101 to S8106, and S8113 to S8118 may be optional, and in different embodiments, one or more of these steps may be omitted or substituted.

In some embodiments, S8102, S8104 to S8106, and S8113 to S8118 may be optional, and in different embodiments, one or more of these steps may be omitted or substituted.

In the embodiments of the present disclosure, part or all of the steps and their optional implementations may be arbitrarily combined with part or all of the steps in other embodiments, and may also be arbitrarily combined with the optional implementations of other embodiments.

FIG. 8B is a flowchart of an information processing method according to an embodiment of the present disclosure. As shown in FIG. 8B, the embodiments of the present disclosure relate to an information processing method. The method includes steps S8201 to S8207.

In some embodiments, a data burst may be: a set of a plurality of PDUs generated and sent by an application within a short period of time. Optionally, the data burst may be composed of one or more PDU sets.

In some embodiments, during a PDU session establishment or modification procedure, the AF may provide a PDU set based QoS parameter and QoS monitoring requirements.

At step S8201, a PDU session establishment procedure is performed.

Optionally, the AF session has QoS requirements.

Optionally, the AF may send information (QoS parameters for each PDU set within the QoS flow, and parameters on frame identification) to the PCF via an Nnef_AFsessionWithQoS_Create request. Optionally, the AF may also provide the information to a 5G system (5GS) prior to PDU session establishment. Optionally, this information includes a protocol description and PDU set related assistance information.

Optionally, the PDU set related assistance information may include the QoS parameters of each PDU set within the QoS flow, for example, including at least one of: a PDU set handling indication, whether all PDUs are needed for usage of the PDU set by an application layer; a PDU set delay budget; or a PDU set error rate. Optionally, the PDU set handling indication indicates whether the PDU set based processing should be activated to the data flow, and the PDU set handling indication may be implicitly indicated via other PDU set related information provided by the AF.

Optionally, the AF provides the QoS monitoring requirements to the NEF/PCF, during the AF QoS request/update procedure; and the QoS monitoring requirements include the TTNB (or the inter burst time). Optionally, the TTNB or the inter burst time may be an interval or a time period from an end time of a previous burst to a start time of a next burst.

At step S8202, SM policy association establishment or modification is performed between the SMF and the PCF.

Optionally, the PCF generates the appropriate PCC rule, which may include PDU set related QoS parameters. The PCF sends the PCC rule to the SMF. The PCF generates PCC rule information, and sends the PCC rule information to the SMF.

Optionally, the PCF generates an authorized QoS monitoring policy (TTNB) for a service data flow based on the QoS monitoring request received from the AF. The PCF includes the authorized QoS monitoring policy (TTNB) in the PCC rule and provides it to the SMF. Optionally, the QoS monitoring policy may be the first request message in the above embodiments.

Optionally, the PDU set related QoS parameters are new QoS parameters for PDU set based QoS handling in a 5GS, and the QoS parameters include at least one of: a PDU set delay budget (PSDB); a PDU set error rate (PSER); a parameter indicating whether all PDUs are needed for usage of the PDU set by an application layer; a parameter indicating whether to drop the PDU set in case PSDB is exceeded; or a priority of the PDU set or a priority of the PDU. “A priority of the PDU set” is the same for all PDU sets (i.e., the same as an existing QoS flow priority), or is different for each PDU set (i.e., the same as “importance of the PDU set”).

Optionally, S8202 is completed during a PDU session establishment procedure, or during a PDU session modification procedure.

Optionally, if the step is triggered by the session modification procedure, the PCF generates the PCC rule information considering the information provided by the AF.

At step S8203, the SMF configures an access network device and a UPF.

Optionally, the SMF generates a QoS profile and N4 rule information based on the PCC rule from the PCF. The SMF sends the N4 rule information to the UPF and sends the QoS profile to an RAN function node (for example, an access network device) via an AMF.

The step is completed via steps 8 to 15 in the PDU session establishment procedure or steps 2 to 7 in the PDU session modification procedure.

Optionally, when the SMF receives an authorized QoS monitoring policy for the TTNB, the SMF configures the UPF to perform the TTNB measurements.

Optionally, the SMF configures the UPF to perform a QoS monitoring policy (TTNB) of the QoS monitoring for a QoS flow, and the QoS monitoring policy may be determined by the SMF based on the authorized QoS monitoring policy received from the PCF and/or local configuration. Optionally, the QoS monitoring policy locally configured at the SMF may be the second policy information in the above embodiments.

Optionally, the SMF configures the UPF to perform (TTNB) QoS monitoring for a QoS flow and report the monitoring report, the monitoring report including: a QoS parameter to be measured indicating a subject of the QoS monitoring (for example, TTNB); a reporting period indicating the time interval in which a new measurement result and a potential report has to be available; a reporting frequency indicating a reporting type as “periodic” or “event triggered”; and a target of the reporting and an indication of a direct event notification indicating that the UPF shall send the reports to a different NF than the SMF (for example, to the local NEF or the AF). Optionally, the report is the monitoring report in the above embodiments.

Optionally, S8202 is completed in a PDU session establishment procedure, or in a PDU session modification procedure.

At step S8204, leftover steps of the PDU session establishment procedure or the PDU session modification procedure are performed.

At step S8205, the UPF identifies the PDU set. Optionally, the UPF performs the QoS monitoring on the PDU set.

Optionally, based on the N4 rule information and/or the local configuration on the UPF, the UPF identifies related information (as follows), and performs PDU set based QoS handling according to the N4 rule.

Optionally, the UPF performs monitoring for the TTNB.

Optionally, the UPF performs (TTNB) monitoring and reports the monitoring results. The UPF reports the TTNB report to the SMF, to the NG-RAN, and/or reports to the local NEF or the AF. Optionally, the TTNB report may be the monitoring report in the above embodiments.

Optionally, after the SMF receives the TTNB report from the UPF, the SMF performs at least one of: the SMF forwards the TTNB report to the NG-RAN (e.g. in an NGAP message), to configure UE power management (e.g. for DRX configuration); or the SMF forwards the TTNB report to the PCF, to determinate the PCC rule; and/or the SMF exposures or notifies the TTNB report to the AF if the AF subscribes the TTNB report.

Optionally, the UPF identifies PDUs belonging to a PDU set and at least one of following information for each PDU set (for example, the related information in the above embodiments): a PDU set sequence number (SN) (The QoS flow is identified using an QoS flow ID and each PDU set within the QoS flow is identified using the PDU set SN. Each QoS flow may be used to deliver one or more PDU sets.); a start or end PDU of the PDU set; a PDU SN within the PDU set; a number of PDUs within the PDU set; PDU set importance; a PDU set size; or an end of a data burst.

Optionally, the UPF identifies the related information via the methods/mechanisms described, as follows:
Option 1: by matching RTP/SRTP header, extension header, and payload;
Option 2: new RTP extension header;
Option 3: by information provided by an application server (AS) in an N6 encapsulation header, e.g. the GTP-U;
Option 4: by detection based on traffic characteristics; and
Option 5: by a specific implementation of the UPF (which may be a non-standardized implementation).

At step S8206, the UPF sends PDU set information to the access network device.

Optionally, the UPF provides the above PDU set related information (listed in the related information of S8205) to the access network device. For the PDU set related information in S8205, the UPF adds them into a GTP-U header.

At step S8207, the access network device performs QoS processing of the PDU set.

Optionally, based on the PDU set related information received at S8206, the access network device performs the QoS processing of the PDU set.

Optionally, when receiving the monitoring report of the TTNB or the inter burst time, the access network device configures UE energy consumption management (for example, for DRX configuration).

In some embodiments, the UPF sends the monitoring report of the TTNB or the inter burst time to the AF. Optionally, the UPF directly sends the monitoring report to the AF. Optionally, the UPF sends the monitoring report to the SMF, the SMF sends the monitoring report to the PCF, and the PCF sends the monitoring report to the AF.

The information processing method involved in the embodiments of the present disclosure may include at least one of S8201a to S8207. For example, S8202 may be implemented as an independent embodiment; S8203 may be implemented as an independent embodiment; S8205 may be implemented as an independent embodiment; a combination of S8203 and S8205 may be implemented as an independent embodiment; a combination of S8203, S8205, and S8206 may be implemented as an independent embodiment; a combination of S8203, S8205, S8206, and S8207 may be implemented as an independent embodiment; and a combination of S8201b, S8203, and S8205 may be implemented as an independent embodiment.

In some embodiments, at least one of S8101a to S8204, and S8206 to S8207 may be omitted.

In some embodiments, S8101a to S8204, and S8206 to S8207 may be optional, and in different embodiments, one or more of these steps may be omitted or substituted.

In some embodiments, S8101a, S8204, S8206, and S8207 may be optional, and in different embodiments, one or more of these steps may be omitted or substituted.

In the embodiments of the present disclosure, part or all of the steps and their optional implementations may be arbitrarily combined with part or all of the steps in other embodiments, and may also be arbitrarily combined with the optional implementations of other embodiments.

The embodiments of the present disclosure further provide an apparatus for implementing any one of the above methods. For example, an apparatus is provided, which includes units configured to perform steps executed by the terminal in any one of the above methods. For another example, another apparatus is provided, which includes units configured to perform steps executed by the network device in any one of the above methods.

It needs to be understood that the division of units in the above apparatuses is merely a division of logical functions. In actual implementations, the units may be fully or partially integrated into a single physical entity or may be physically separated. In addition, the units in the apparatus may be implemented in a form of a processor invoking software. For example, the apparatus includes a processor, which is connected to a memory for storing computer instructions. The processor invokes the computer instructions stored in the memory to implement any one of the above methods or the functions of the units in the apparatus. The processor may be a general-purpose processor, such as a central processing unit (CPU) or a microprocessor, and the memory may be internal or external to the apparatus. Or, the units in the apparatus may be implemented in a form of a hardware circuit. Some or all of the functions of the units may be realized via a design of the hardware circuit. The hardware circuit may be understood as one or more processors. For example, in an implementation, the hardware circuit is an application-specific integrated circuit (ASIC). Functions of some or all of the units are realized by designing logical relationships among components in the circuit. In another implementation, the hardware circuit may be implemented using a programmable logic device (PLD). Taking a field programmable gate array (FPGA) as an example, the FPGA may include a large number of logic gate circuits, and connection relationships among the logic gate circuits are configured by configuration files to realize the functions of some or all of the units. All units of the above apparatus may be fully implemented in a form of the processor invoking software, or fully implemented in a form of the hardware circuit, or partially implemented in a form of the processor invoking software and the remaining part implemented in a form of the hardware circuit.

In the embodiments of the present disclosure, the processor is a circuit with a signal processing capability. In an implementation, the processor may be a circuit capable of reading and executing instructions, such as a central processing unit (CPU), a microprocessor, a graphics processing unit (GPU) (which may be understood as a microprocessor), or a digital signal processor (DSP). In another implementation, the processor may realize certain functions via a logical relationship of the hardware circuit. The logical relationship of the hardware circuit may be fixed or reconfigurable. For example, the processor may be a hardware circuit implemented as an ASIC or PLD, such as an FPGA. In a reconfigurable hardware circuit, a process in which the processor loads configuration files to configure the hardware circuit may be understood as a process that the processor loads instructions to realize the functions of some or all of the units. In addition, the hardware circuit may be designed specifically for artificial intelligence and may be understood as an ASIC, such as a neural network processing unit (NPU), a tensor processing unit (TPU), or deep learning processing unit (DPU).

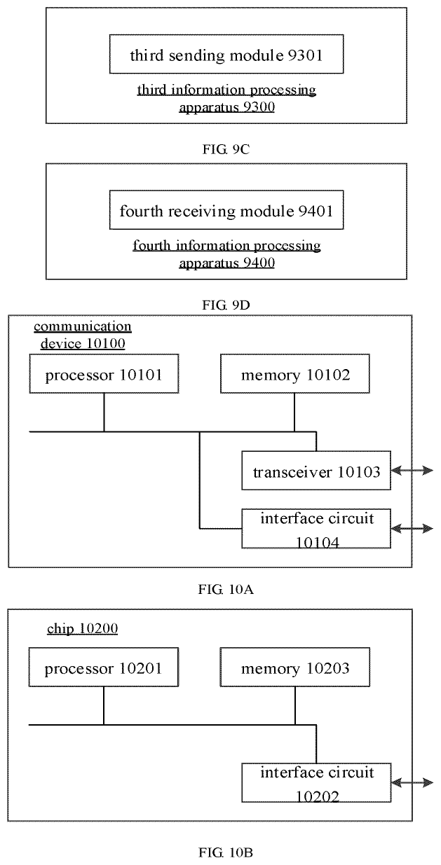

FIG. 9A is a block diagram of a first information processing apparatus according to an embodiment of the present disclosure. As shown in FIG. 9A, the first information processing apparatus 9100 includes: a first sending module 9101, configured to send a first request message. Optionally, the first sending module 9101 is configured to perform steps related to sending that is performed by the first network element in any one of the above methods, which is not repeated here. Optionally, the first information processing apparatus 9100 further includes a first receiving module, in which the first receiving module is configured to perform steps related to receiving that is performed by the first network element in any one of the above methods, which is not repeated here.

FIG. 9B is a block diagram of a second information processing apparatus according to an embodiment of the present disclosure. As shown in FIG. 9B, the second information processing apparatus 9200 includes: a second receiving module 9201, configured to receive a first request message. Optionally, the second receiving 9201 is configured to perform steps related to receiving that is performed by the second network element in any one of the above methods, which is not repeated here. Optionally, the second information processing apparatus 9200 further includes a second sending module, in which the second sending module is configured to perform steps related to sending that is performed by the second network element in any one of the above methods, which is not repeated here. Optionally, the second information processing apparatus 9200 further includes a first processing module, in which the first processing module is configured to perform steps related to processing that is performed by the second network element in any one of the above methods, which is not repeated here.

FIG. 9C is a block diagram of a third information processing apparatus according to an embodiment of the present disclosure. As shown in FIG. 9C, the third information processing apparatus 9300 includes: a third sending module 9301, configured to send a second request message to a fifth network element. Optionally, the third sending module 9301 is configured to perform steps related to sending that is performed by the fourth network element in any one of the above methods, which is not repeated here. Optionally, the third information processing apparatus 9300 further includes a third receiving module, in which the third receiving module is configured to perform steps related to receiving that is performed by the fourth network element in any one of the above methods, which is not repeated here. Optionally, the third information processing apparatus 9300 further includes a second processing module, in which the second processing module is configured to perform steps related to processing that is performed by the fourth network element in any one of the above methods, which is not repeated here.

FIG. 9D is a block diagram of a fourth information processing apparatus according to an embodiment of the present disclosure. As shown in FIG. 9D, the fourth information processing apparatus 9400 includes: a fourth receiving module 9401, configured to receive a second request message sent by a second network element. Optionally, the fourth receiving module 9401 is configured to perform steps related to receiving that is performed by the fifth network element in any one of the above methods, which is not repeated here. Optionally, the fourth information processing apparatus 9400 further includes a fourth sending module, in which the fourth sending module is configured to perform steps related to sending that is performed by the fifth network element in any one of the above methods, which is not repeated here. Optionally, the fourth information processing apparatus 9400 further includes a third processing module, in which the third processing module is configured to perform steps related to processing that is performed by the fifth network element in any one of the above methods, which is not repeated here.

FIG. 10A is a block diagram of a structure of a communication device 10100 according to an embodiment of the present disclosure. The communication device 10100 may be a network device (e.g., an access network device, a core network device, etc.), or a terminal (e.g., a user equipment, etc.), or a chip, a chip system, or a processor that supports the network device to implement any one of the above methods, or a chip, a chip system, or a processor that supports the terminal to implement any one of the above methods. The communication device 10100 may be configured to implement the methods described in the above method embodiments. For details, reference may be made to the descriptions in the above method embodiments.

As shown in FIG. 10A, the communication device 10100 includes one or more processors 10101. The processor 10101 may be a general-purpose processor or a dedicated processor, such as, a baseband processor and a central processor. The baseband processor is used for processing communication protocols and communication data. The central processor is used for controlling the communication device (e.g., a base station, a baseband chip, a terminal, a terminal chip, a DU, or a CU), executing programs, and processing data of the programs. The processor 10101 is configured to invoke instructions to cause the communication device 10100 to implement any one of the above methods.

In some embodiments, the communication device 10100 further includes one or more memories 10102 for storing instructions. Optionally, all or some of the memories 10102 may also be located outside the communication device 10100.

In some embodiments, the communication device 10100 further includes one or more transceivers 10103. When the communication device 10100 includes one or more transceivers 10103, communication steps such as sending and receiving in the above methods are implemented by the transceiver 10103, and other steps are implemented by the processor 10101.

In some embodiments, the transceiver may include a receiver and a transmitter, which may be separate or integrated together. Optionally, terms such as transceiver, transceiver unit, transceiver machine, transceiver circuit, etc. may be used interchangeably; terms such as transmitter, sending unit, transmitter machine, sending circuit, etc. may be used interchangeably; and terms such as receiver, receiving unit, receiver machine, receiving circuit, etc. may be used interchangeably.

Optionally, the communication device 10100 further includes one or more interface circuits 10104. The interface circuit 10104 is connected to the memory 10102 and may be used to receive signals from the memory 10102 or other devices, or send signals to the memory 10102 or other devices. For example, the interface circuit 10104 may read instructions stored in the memory 10102 and send the instructions to the processor 10101.

The communication device 10100 in the description of the above embodiments may be a network device or a terminal, but the scope of the communication device 10100 described in the disclosure is not limited thereto, and the structure of the communication device 10100 may not be limited by FIG. 10A. The communication device may be a stand-alone device or may be part of a larger device. For example, the communication device may be: (1) a stand-alone IC, a chip, a chip system or a subsystem; (2) a collection of ICs including one or more ICs. In some examples, the collection of ICs may also include storage components for storing data and computer programs; (3) an ASIC, such as a modem; (4) a module that may be embedded within other devices; (5) a receiver, a terminal, a smart terminal, a cellular phone, a wireless device, a handheld machine, a mobile unit, an in-vehicle device, a network device, a cloud device, an artificial intelligence device, and the like; and (6) others.

FIG. 10B is a block diagram of a structure of a chip 10200 according to an embodiment of the present disclosure. For a case where the communication device 10100 may be a chip or chip system, reference may be made to the block diagram of the structure of the chip 10200 shown in FIG. 10B, which is not limited to this.

The chip 10200 includes one or more processors 10201, and the processor 10201 is configured to invoke instructions to cause the chip 10200 to implement any one of the above methods.

In some embodiments, the chip 10200 further includes one or more interface circuits 10202. The interface circuit 10202 is connected to a memory 10203 and may be configured to receive signals from the memory 10203 or other devices, or send signals to the memory 10203 or other devices. For example, the interface circuit 10202 may read instructions stored in the memory 10203 and send the instructions to the processor 10201. Optionally, terms such as interface circuit, interface, transceiver pin, transceiver, etc. may be used interchangeably.

In some embodiments, the chip 10200 further includes one or more memories 10203 for storing computer instructions. Optionally, all or some of the memories 10203 may be located outside the chip 10200.

The present disclosure also provides a storage medium for storing instructions. When the instructions are running on the communication device 10100, the communication device 10100 is caused to implement any one of the above methods. Optionally, the storage medium is an electronic storage medium. Optionally, the storage medium is a computer-readable storage medium, but it may also be a storage medium readable by other devices. Optionally, the storage medium may be a non-transitory storage medium, but it may also be a transitory storage medium.

The present disclosure also provides a program product. When the program product is executed by the communication device 10100, the communication device 10100 is caused to implement any one of the above methods. Optionally, the program product is a computer program product.

The present disclosure also provides a computer program. When the computer program is executed on a computer, the computer is caused to implement any one of the above methods.

1. An information processing method, performed by a communication system, wherein the communication system comprises a first network element, the method comprising:
sending, by the first network element, a first request message, wherein the first request message is configured to request first information of quality of service (QoS) monitoring; and the first information indicates at least one of:
a time to next burst (TTNB); or
a TTNB and a time interval between starts of two bursts.

2. The method of claim 1, wherein sending, by the first network element, the first request message comprises one of:
sending, by the first network element, the first request message in an application function (AF) session establishment procedure; or
sending, by the first network element, the first request message in an AF session modification procedure.

3. The method of claim 1, wherein sending, by the first network element, the first request message comprises one of:
sending, by the first network element, the first request message to a second network element; or
sending, by the first network element, the first request message to a second network element via a third network element; or
sending, by the first network element, the first request message to a core network device.

4. The method of claim 1, further comprising one of:
receiving, by the first network element, a monitoring report of the first information sent by a second network element; or
receiving, by the first network element, a monitoring report of the first information sent by a second network element via a third network element; or
receiving, by the first network element, a monitoring report of the first information sent by a core network device after the core network device performs the QoS monitoring.

5-7. (canceled)

8. The method of claim 3, wherein the communication system further comprises a second network element and a fourth network element, and the method further comprises:
determining, by the second network element, first policy information based on the first request message, wherein the first policy information indicates a policy of the QoS monitoring; and
sending, by the second network element, the first policy information to the fourth network element.

9. The method of claim 8, wherein sending, by the second network element, the first policy information to the fourth network element, comprises:
sending, by the second network element, policy and charging control (PCC) rule information to the fourth network element, wherein the PCC rule information comprises the first policy information.

10. The method of claim 4, wherein receiving, by the first network element, the monitoring report of the first information sent by the second network element comprises:
receiving, by the second network element, the monitoring report of the first information sent by a fourth network element; and
receiving, by the first network element, the monitoring report sent by the second network element.

11. (canceled)

12. The information processing method of claim 8, wherein the communication system further comprises a fifth network element, and the method further comprises:
sending, by the fourth network element, a second request message to the fifth network element, wherein the second request message indicates the fifth network element to perform the QoS monitoring, and the second request message is configured to request the first information of the QoS monitoring.

13-14. (canceled)

15. The method of claim 12, wherein the second request message comprises policy information, and the policy information comprises at least one of the first policy information or second policy information; and
the method further comprises: determining, by the fourth network element, the second policy information based on at least one of the first policy information or local configuration information.

16. The method of claim 15, wherein the policy information comprises at least one of:
first indication information, indicating a monitoring object of the QoS monitoring;
second indication information, indicating a period for reporting a monitoring report of the first information;
third indication information, indicating a reporting type for reporting a monitoring report of the first information, wherein the reporting type comprises: a periodic reporting type or an event triggered reporting type; or
fourth indication information, indicating a target object to which a monitoring report of the first information is reported, wherein the target object comprises at least one of: an access network device, the first network element, the second network element, the third network element, or the fourth network element.

17. The method claim 12, further comprising:
receiving, by the fourth network element, a monitoring report of the first information sent by the fifth network element.

18. The method of claim 17, further comprising at least one of:
sending, by the fourth network element, the monitoring report to the second network element;
sending, by the fourth network element, the monitoring report to an access network device via a sixth network element;
sending, by the fourth network element, the monitoring report to an access network device via a next generation application protocol (NGAP) message;
sending, by the fourth network element, the monitoring report to the first network element; or
sending, by the fourth network element, the monitoring report to the third network element via the second network element.

19. The method of claim 18, wherein the first network element is an application function (AF); and/or the second network element is a policy control function (PCF); and/or the third network element is a network exposure function (NEF); and/or the fourth network element is a session management function (SMF); and/or the fifth network element is a user plane function (UPF); and/or the sixth network element is an access and mobility management function (AMF).

20-34. (canceled)

35. A communication system, comprising:
a first network element, configured to send a first request message, wherein the second request message is configured to request first information of quality of service (QoS) monitoring; and the first information indicates at least one of:
a time to next burst (TTNB); or
a TTNB and a time interval between starts of two bursts.

36. (canceled)

37. The communication system of claim 35, further comprising:
a second network element, configured to receive the first request message, and determine first policy information based on the first request message, wherein the first policy information indicates a policy of the QoS monitoring.

38. The communication system of claim 37, further comprising:
a fourth network element, configured to receive the first policy information, determine policy information, and send a second request message;
wherein the second request message indicates the QoS monitoring, and the second request message is configured to request the first information of the QoS monitoring,
wherein the policy information comprises at least one of the first policy information or second policy information, the second policy information is determined based on at least one of the first policy information or local configuration information, and the policy information indicates a policy of the QoS monitoring.

39. The communication system of claim 38, further comprising:
a fifth network element, configured to receive the second request message, perform the QoS monitoring based on the second request message, and generate a monitoring report of the first information.

40. The communication system of claim 39, wherein the fifth network element is further configured to:
send the monitoring report to the fourth network element; or
send the monitoring report to an access network device; or
send the monitoring report to the first network element; or
send the monitoring report to the second network element; or
send the monitoring report to a third network element.

41. The communication system of claim 40, wherein in a case that the fifth network element sends the monitoring report to the fourth network element, the fourth network element is further configured to:
send the monitoring report to the second network element, so that the second network element sends the monitoring report to the first network element directly or via the third network element; or
send the monitoring report to a sixth network element, so that the sixth network element sends the monitoring report to the access network device;
wherein in a case that the fifth network element sends the monitoring report to the third network element, the third network element is further configured to send the monitoring report to the first network element.

42. The communication system of claim 39, wherein the first network element is an application function (AF); and/or the second network element is a policy control function (PCF); and/or the third network element is a network exposure function (NEF); and/or the fourth network element is a session management function (SMF); and/or the fifth network element is a user plane function (UPF); and/or the sixth network element is an access and mobility management function (AMF).
